(19) United States
(12) Patent Application Publication
(10) Pub. No.: US 2025/0390751 A1
(43) Pub. Date: Dec. 25, 2025

(54) THERMODYNAMIC COMPUTING SYSTEM CONFIGURED TO TRAIN PARAMETERS BASED ON DIFFUSION RECOVERY LIKELIHOOD

(71) Applicant: Extropic Corp., Austin, TX (US)

(72) Inventors: Christopher Chamberland, Austin, TX (US); Guillaume Verdon-Akzam, San Francisco, CA (US)

(73) Assignee: Extropic Corp., Austin, TX (US)

(21) Appl. No.: 19/234,912

(22) Filed: Jun. 11, 2025

Related U.S. Application Data
(60) Provisional application No. 63/662,939, filed on Jun. 21, 2024.

(51) Int. Cl. G06N 3/084; G06N 3/0475; G06N 3/065

(52) U.S. Cl. CPC G06N 3/084; G06N 3/0475; G06N 3/065

(57) ABSTRACT

A thermodynamic computing chip that is configured to emulate deep neural diffusion of a deep energy-based model (EBM) and update parameters of an energy function using diffusion recovery likelihood is disclosed. In some embodiments, a deep EBM may comprise one or more EBMs that process thermodynamic information via thermodynamic evolution. Relay oscillators or measurements may be utilized to obtain gradients of the deep EBM and sampled input values used to update parameters of the energy function.

### RELATED APPLICATION

This application claims benefit of priority to U.S. Provisional Application Ser. No. 63/662,939, entitled “THERMODYNAMIC COMPUTING SYSTEM CONFIGURED TO TRAIN PARAMETERS OF AN ENGINEERED ENERGY FUNCTION USING A DIFFUSION RECOVERY LIKELIHOOD PROTOCOL,” filed Jun. 21, 2024, and which is incorporated herein by reference in its entirety.

### DESCRIPTION OF RELATED ART

Various algorithms, such as machine learning algorithms, often use statistical probabilities to make decisions or to model systems. Some such learning algorithms may use Bayesian statistics, or may use other statistical models that have a theoretical basis in natural phenomena. In the execution of such algorithms, typically such statistical probabilities are calculated using classical computing devices, wherein the statistical probabilities are then used by other aspects of the algorithm. As an example, statistical probabilities may be used to generate a random number, wherein the random number is then used to evaluate some other aspect of the algorithm.

Generating such statistical probabilities may involve performing complex calculations which may require both time and energy to perform, thus increasing a latency of execution of the algorithm and/or negatively impacting energy efficiency. In some scenarios, calculation of such statistical probabilities using classical computing devices may result in non-trivial increases in execution time of algorithms and/or energy usage to execute such algorithms.

### BRIEF DESCRIPTION OF THE DRAWINGS

FIG. 1A is a high-level diagram illustrating one or more thermodynamic chips comprising oscillators, wherein the oscillators may thermodynamically evolve to obtain sample data and train parameters of an energy based model (EBM), according to some embodiments.

FIG. 1B is a flowchart describing updating parameters of an energy based model (EBM) based on input including observed data, number of noise levels, number of Langevin sampling steps, Langevin step size at each noise level, and a learning rate, according to some embodiments.

FIG. 1C is a flowchart describing updating parameters of an energy based model (EBM) based on a plurality of Langevin sampling steps, according to some embodiments.

FIG. 1D is a high-level diagram illustrating architecture used to obtain sample data at each noise level, according to some embodiments.

FIG. 1E is a high-level diagram illustrating a deep energy-based model (EBM) implemented on one or more thermodynamic chips, wherein a plurality of EBMs are implemented in hardware to implement the deep EBM, according to some embodiments.

FIG. 2 is a high-level diagram illustrating sets of relay oscillators configured to be coupled to oscillators of a deep energy-based model (EBM), wherein the coupling enables gradient terms to be obtained to emulate deep neural diffusion of the deep EBM, according to some embodiments.

FIG. 3 is a high-level diagram illustrating oscillators of a deep energy-based model (EBM) configured to be measured, wherein the measurements enable gradient terms to be obtained to emulate deep neural diffusion of the deep EBM, according to some embodiments.

FIG. 4 is a high-level diagram illustrating a deep energy-based model (EBM), which may be used to sample input values, according to some embodiments.

FIG. 5 is a diagram illustrating hardware components that may be used to implement oscillators of energy-based models (EBMs), as well as two different example hardware configurations of a relay oscillator that have a time-dependent mass or a time-dependent frequency, respectively, according to some embodiments.

FIG. 6 is a diagram providing additional details regarding a hardware configuration used to implement a relay oscillator with a time-dependent frequency, according to some embodiments.

FIG. 7 is a diagram providing additional details regarding a hardware configuration used to implement a relay oscillator with a time-dependent mass, according to some embodiments.

FIG. 8 is a high-level diagram illustrating an output oscillator, an input oscillator, and a relay gadget, wherein the relay gadget comprises a group of relay oscillators and is configured to relay thermodynamic information between the output oscillator and the input oscillator and includes bias oscillators, according to some embodiments.

FIG. 9 is a high-level diagram illustrating a spatial analogue relay gadget, wherein respective ones of relay oscillators of a group of relay oscillators are configured to store respective sample values of an output oscillator, according to some embodiments.

FIG. 10 is a high-level diagram illustrating a temporal analogue relay gadget, wherein a group of relay oscillators comprises a single relay oscillator, according to some embodiments.

FIG. 11 is a high-level diagram illustrating a series analogue relay gadget, wherein a group of relay oscillators comprises a plurality of relay oscillators arranged in series, according to some embodiments.

FIG. 12A illustrates example couplings between visible neurons of an energy-based model (EBM), according to some embodiments.

FIG. 12B illustrates example couplings between visible neurons and non-visible neurons (e.g., hidden neurons) of an energy-based model (EBM), according to some embodiments.

FIG. 13 is a high-level diagram illustrating oscillators included in a substrate of the thermodynamic chip and mapping of the oscillators to logical neurons of the thermodynamic chip, according to some embodiments.

FIG. 14 is an additional high-level diagram illustrating oscillators included in a substrate of the thermodynamic chip mapped to logical neurons, weights, and biases of a given neuro-thermodynamic computing system, according to some embodiments.

FIG. 15 is a high-level flowchart illustrating a process of emulating deep neural diffusion using a deep energy-based model implemented on one or more thermodynamic chips to generate sample values, according to some embodiments.

FIG. 16 is a block diagram illustrating an example computer system that may be used in at least some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof.

### DETAILED DESCRIPTION

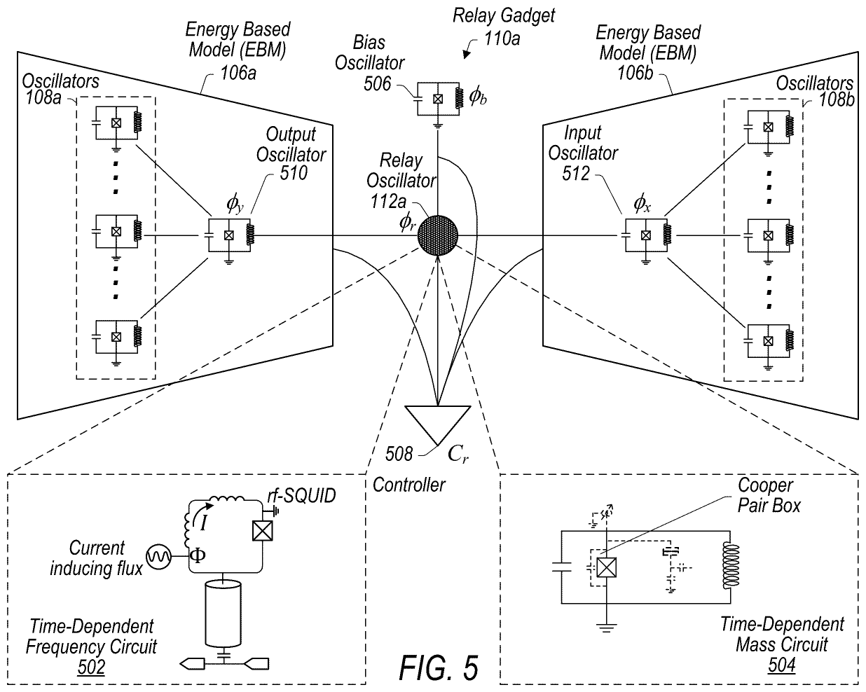

The present disclosure relates to methods and apparatuses for training a deep energy-based model (EBM) using mean field approach. For example, a mean field protocol can be used to train parameters of some complicated energy function using diffusion recovery likelihood (DRL). The energy function may be implemented in hardware using oscillators. Such an approach may use a deep EBM (implementing the energy function) comprising K≥1 EBMs that can be implemented in hardware, and which are chosen such that the expectation value of the final output of the deep EBM is equal to the energy function of interest used in DRL. The mean field approach such as described herein may then be used to obtain gradients of this energy function, which in turn can be used to obtain sample data used in DRL on an external classical post-processing device. Components of the deep EBM may be constructed in hardware such as illustrated in FIGS. 5-7 and 13-14. Gradients of a deep EBM may be calculated using methods disclosed herein, wherein sample input values may be generated and applied to DRL training.

In some embodiments, a system may comprise one or more classical computing devices and one or more thermodynamic chips. The classical computing devices may be configured to cause noise to be added to observed data according to a given noise level (t) to generate noisy observed data (yₜ). The one or more thermodynamic chips may comprise oscillators that implement a deep energy based model (EBM). The deep EBM may implement an energy function (ε_{θ}) and be made up of one or more EBMs. Oscillators are configured to encode thermodynamic information in a position degree of freedom or a momentum degree of freedom and thermodynamically evolve. Furthermore, there may be different oscillators used for different purposes. For example, respective oscillators of the deep EBM may be neuron oscillators representing neuron values. Other respective oscillators of the deep EBM may be synapse oscillators representing trainable parameters (θ). One or more input oscillators may be configured to provide input thermodynamic information to the deep EBM based on the noisy observed data. The thermodynamic chip may include an output gadget, comprising one or more output oscillators, configured to receive output thermodynamic information from the deep EBM, wherein the output gadget stores an expectation value of the output thermodynamic information. Furthermore, the one or more classical computing devices may be further configured to cause the noisy observed data to be provided to the one or more input oscillators; cause the oscillators that implement the deep EBM to thermodynamically evolve; obtain a gradient of the deep EBM with respect to the noisy observed data (∇_{y}_{ₜ}ε_{θ}(yₜ; t)); determine sampled data (\tilde{y}ₜ) based on the gradient of the deep EBM (∇_{y}_{ₜ}ε_{θ}(yₜ; t)), wherein the sampled data (\tilde{y}ₜ) represents one or more instances of input data sampled from a distribution conditional to a higher noise level (\tilde{y}ₜ˜p_{θ}(yₜ|xₜ₊₁)); and cause the synapse oscillators representing trainable parameters (θ) to be updated based on the noisy observed data (yₜ) and the sampled data (\tilde{y}ₜ).

In some embodiments, a deep EBM may have of many EBM blocks, and the expectation value of the output of one EBM block is used as input to the next EBM block, for example, by using the relay oscillator methods (see FIGS. 5-11). The EBM blocks are chosen such that they can be implemented in hardware (see FIGS. 5-7), and where the expectation value of the output of the final EBM block corresponds to a function of interest (say ƒ_{θ}(x) or ε_{θ}(y) for some input x or y to the deep EBM). Such a function may be the energy function of some complicated EBM, or any other function of interest that can be achieved using mean-field methods. Back-propagation may be performed to obtain the gradient ∇ₓƒ_{θ}(x) (or ∇_{y}ε_{θ}(y)). As used herein, a gradient may indicate how a change in some variable is related to a change in another variable or output. For example, a gradient may indicate a relationship between how a change in input values or parameters of a function is related to a change in the output of the function. In some embodiments, a gradient may be considered how sensitive a function is to changes in inputs or parameters of the function. The function may be implemented in hardware using deep EBMs and components such as superconducting quantum interference devices or cooper pair box (see FIGS. 5-7). As used herein, ƒ_{θ} may refer to an overall function of interest that is implemented using a physical deep EBM. Similarly, ε_{θ} may refer to an overall function of interest that is implemented using a physical deep EBM.

In some embodiments, the mean-field protocol can be used to train parameters (e.g., θ) of some complicated energy function (e.g., ε_{θ}(y)) using a diffusion recovery likelihood (DRL) protocol. The mean-field approach may use a deep EBM consisting of K≥1 EBMs that can be implemented in hardware, and which are chosen such that the expectation value of the final output of the last EBM is equal to the energy function of interest used in DRL. The mean field approach can then be used to obtain gradients of this energy function, which in turn can be used to obtain the desired samples used in DRL on an external classical post-processing device.

The following illustrates an example of a DRL protocol. Note that equations 2.1-2.26 reuse symbols that may have different definitions as compared to the definition of symbols in equations 1.1-1.11. In DRL, parameters for a sequence of EBMs are trained as follows. First, a sequence of noise perturbed training examples {x₀,x₁, . . . ,x_{T}} are generated where x₀˜p_{data} (e.g., input x₀ may be an image, video, document, audio file, other multi-media file, etc.) and

$${x}_{t + 1} = {α}_{t + 1} {x}_{t} + {σ}_{t + 1} ϵ ,$$

(equation 1.1) where noise ϵ may be sampled from a Gaussian distribution with mean 0 and variance 1 (e.g., ϵ˜ [symbol] (0, I)) and factor αₜ=\sqrt{1−σₜ} to ensure a variance-preserving noise schedule. Also, xₜ may be sampled at an arbitrary noise schedule starting directly from input data x₀ by using

$${x}_{t} = {\overline{α}}_{t} {x}_{0} + {\overline{σ}}_{t} ϵ ,$$

(equation 1.2) where e

$${\overline{α}}_{t} = {\prod }_{j = 1}^{t} {α}_{j}$$

and σ̅ₜ=\sqrt{1−α̅ₜ}. Noisy input data may also be define by

$${y}_{t} = {α}_{t + 1} {x}_{t}$$

(equation 1.3). The noisy observed data may include a modified version of the image with noise added according to the given noise level (t), a modified version of the video with noise added according to the given noise level (t), a modified version of the document with changes added (noise) according to the given noise level (t), a modified version of the audio file with noise added according to the given noise level (t), or a modified version of the another multi-media file with noise added according to the given noise level (t). The marginal distributions {yₜ; t=1, . . . , T} are modelled by a sequence of EBMs

$${p}_{θ} ( {y}_{t} ) = \frac{{e}^{- {ε}_{θ} ( {y}_{t} ; t )}}{Z ( θ ; t )}$$

(equation 1.4). The conditional EBM of noisy input data with noise level t (e.g., yₜ) given the sample at the higher noise level t+1 is given by

$${p}_{θ} ( {y}_{t} \vert {x}_{t + 1} ) = \frac{1}{\tilde{Z} ( θ , {x}_{t + 1} )} exp ( - ( {ε}_{θ} ( {y}_{t} ; t ) + \frac{1}{2 {σ}_{t + 1}^{2}} {‖ {y}_{t} - {x}_{t + 1} ‖}^{2} ) )$$

(equation 1.5). Note that the same parameters θ are used for each noise level. Sampling from the conditional distribution in equation 1.5 may generally be easier than the marginal distribution p_{θ}(yₜ) due to the quadratic term which constrains the conditional energy landscape to be around yₜ, thus making the distribution less multi-modal. The model parameters θ are estimated using the log-likelihood function

$${𝒥}_{t} ( θ ) = \frac{1}{n} {\sum }_{i = 1}^{n} log {p}_{θ} ( {y}_{t , i} \vert {x}_{t + 1 , i} )$$

(equation 1.6) Computing the gradient of the log-likelihood function [symbol] ₜ(θ) in equation 1.6 requires sampling from the conditional distribution p_{θ}(y_{t,i}|x_{t+1,i}). In particular, a gradient of the log-likelihood function may be written as

$${∇}_{θ} {𝒥}_{t} ( θ ) = - \frac{1}{n} {\sum }_{i = 1}^{n} [ {∇}_{θ} {ε}_{θ} ( {y}_{t , i} ; t ) - {∇}_{θ} {E}_{θ} ( {\tilde{y}}_{t , i} ; t ) ] ,$$

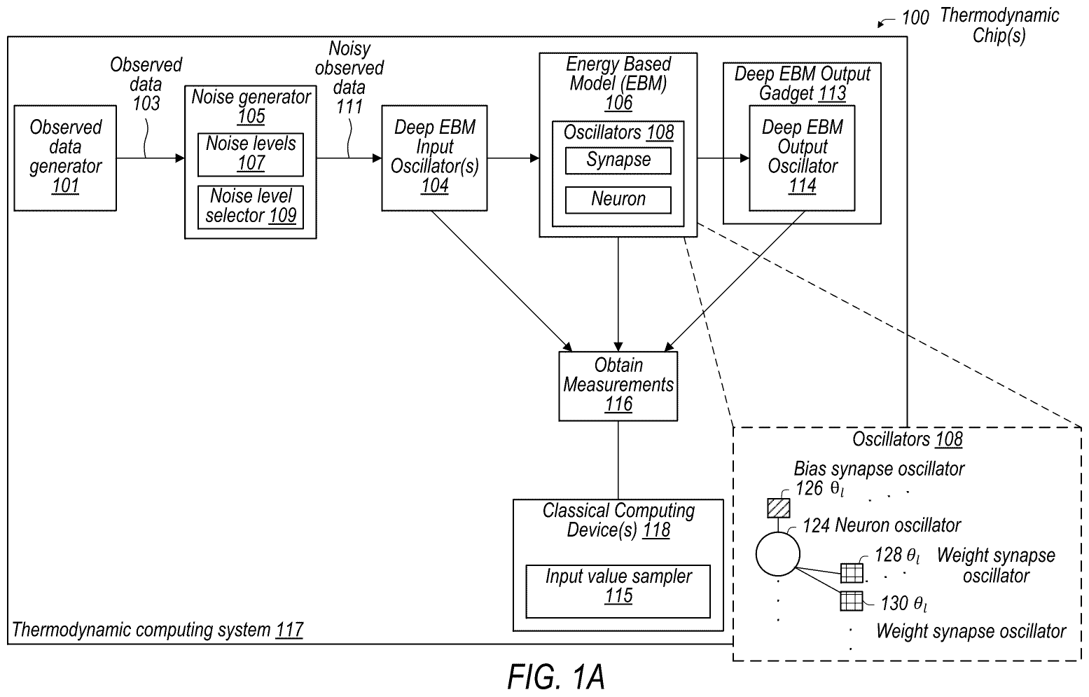

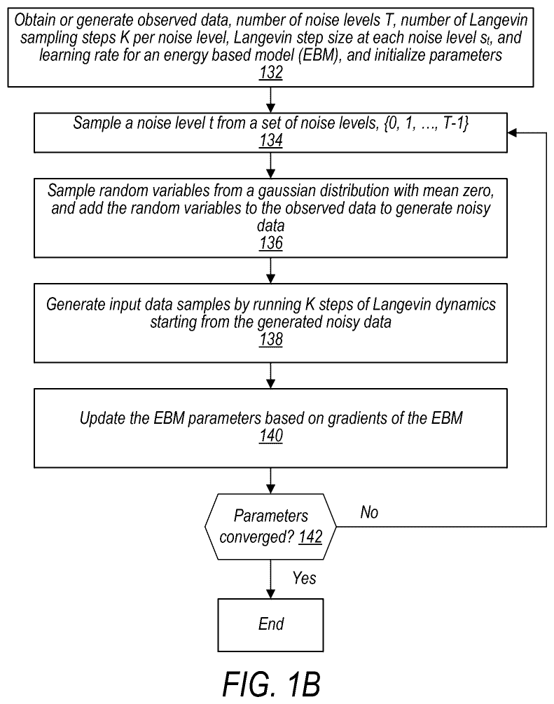

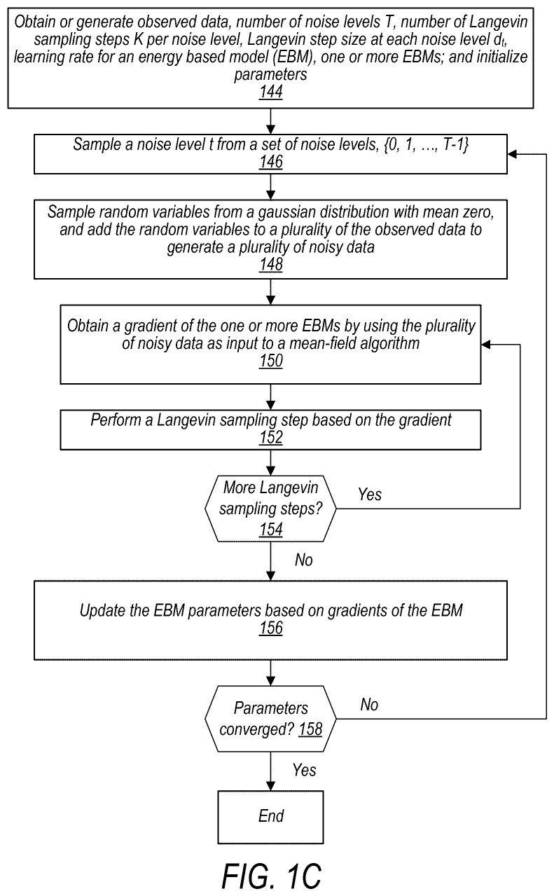

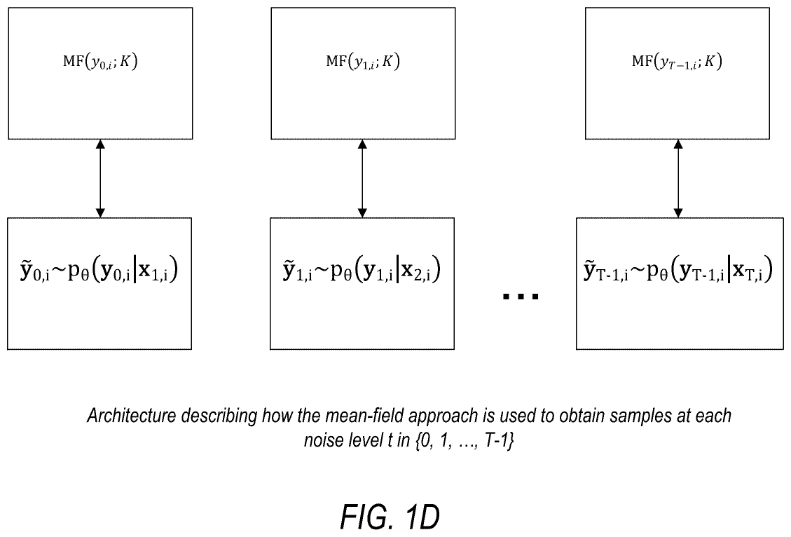

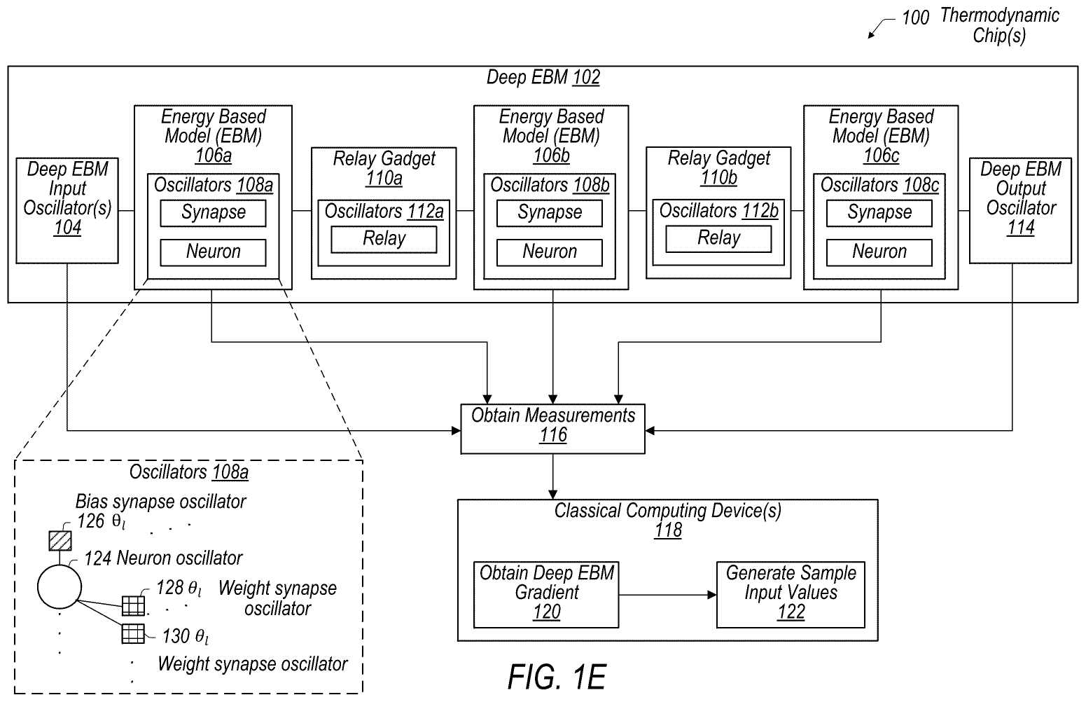

(equation 1.7) where sampled data \tilde{y}_{t,i}˜p_{θ}(y_{t,i}|x_{t+1,i}). Lastly, standard DRL initializes the Markov chain Monte Carlo (MCMC) sampling of the conditional distribution p_{θ}(yₜ|xₜ₊₁) at xₜ₊₁ which may be far from the data manifold of yₜ. Thus, to cause the synapse oscillators, representing trainable parameters (θ), to be updated based on the noisy observed data (yₜ) and the sampled data (\tilde{y}ₜ), the system may determine a gradient of the deep EBM with respect to the synapse oscillators given the noisy observed data (∇_{θ}ε_{θ}(yₜ; t)), and determine a gradient of the deep EBM with respect to the synapse oscillators given the sampled data (∇_{θ}ε_{θ}(\tilde{y}ₜ; t)). These gradients may be determined using the mean field protocol discussed in FIGS. 1E-4. Furthermore, the gradient of the deep EBM with respect to the synapse oscillators given the noisy observed data (∇_{θ}ε_{θ}(yₜ; t)) may be combined with the gradient of the deep EBM with respect to the synapse oscillators given the sampled data (∇_{θ}ε_{θ}(\tilde{y}ₜ; t)), to obtain a difference of gradients as described by equation 1.7.

Furthermore, in some embodiments, a plurality of instances (i∈{1,2, . . . , n}) of observed data may be used. For a given instance (i) of the plurality of instances of observed data, the following may be performed to update parameters. Noise may be added to the instance of observed data according to the given noise level (t), wherein the instance of noisy observed data (y_{t,i}) is used as input to the deep EBM. The oscillators of the deep EBM may thermodynamically evolve, wherein the thermodynamic evolution enables a gradient of the deep EBM with respect to the instance of noisy observed data (∇_{y}_{_{t,i}}ε_{θ}(y_{t,i}; t)) to be determined. A gradient of the deep EBM with respect to the noisy observed data (∇_{y}_{_{t,i}}ε_{θ}(y_{t,i}; t)) may be determined. An instance of sampled data (\tilde{y}_{t,i}) may be determined based on the gradient of the deep EBM (∇_{y}_{_{t,i}}ε_{θ}(y_{t,i}; t)), wherein the sampled data (\tilde{y}_{t,i}) represents one or more instances of input data sampled from a distribution conditional to a higher noise level (\tilde{y}_{t,i}˜p_{θ}(y_{t,i}|x_{t+1,i})). For example, sampled data may be a generated image. An average parameter update may be determined based on the instance of noisy observed data and the instance of sampled data, such as described by equation 1.6. Thus, the synapse oscillators, representing trainable parameters (θ), may be updated based on the determined average parameter update.

An algorithm for DRL training may be represented by the following.

| | |
|---|---|
| 1: | Input: (1) Observed data x₀ ~ p_{data}(x); (2) Number of noise levels T; (3) Number of |
| | Langevin sampling steps K per noise level; (4) Langevin step size at each noise level sₜ; |
| | (5) Learning rate η_{θ} for EBM ε_{θ}; |
| 2: | Output: Parameters θ. |
| 3: | Randomly initialize θ. |
| 4: | Repeat |
| 5: | Sample noise level t from {0,1, ... , T − 1}. |
| 6: | Sample error ϵ ~ [symbol] (0, I). Let xₜ₊₁ = α̅ₜ₊₁x₀ + σ̅ₜ₊₁ϵ, yₜ = αₜ₊₁(α̅ₜx₀ + σ̅ₜϵ). |
| 7: | Generate the sample data \tilde{y}ₜ by running K steps of Langevin dynamics starting from |
| | xₜ₊₁. |
| 8: | Update the EBM parameters θ following the gradients in equation 1.7. |
| 9: | Until converged |

While equilibrium-based thermodynamic processors are able to sample from deep latent variable probabilistic models, there are many applications where a fully visible model is preferred. There are classes of algorithms where sampling and training involve emulating diffusion in a landscape parameterized by a deep neural network. Such Machine Learning algorithms include Deep Energy-Based Models (Deep EBMs), Denoising Diffusion Probabilistic Models, Diffusion Recovery Likelihood Models, and Neural Stochastic Differential Equations. In some embodiments, mean-field inference techniques for neural networks on thermodynamic processors, a mean-field backpropagation to obtain gradients of such parameterized functions, and time-scale separated effective dynamics may be combined to enact this broader class of diffusion, EBM, DRL, NSDE, algorithms as hardware physics.

In some embodiments that use a mean-field architecture, there may be K≥1 EBM blocks, where the expectation value of the output of a given EBM block, [symbol] νₗ [symbol] , is used as input for the next EBM, wₗ, through the use of relay oscillators. For example, wₗ= [symbol] νₗ [symbol] for EBM block l. The output, ν_{K}, of the final EBM block satisfies [symbol] ν_{K} [symbol] =ε_{θ}(y). In deep neural diffusion, it is desired to sample the input by computing the gradient of the EBM function using mean-field forwards and backwards propagation methods.

In some embodiments, mean-field methods may be used to obtain the samples needed for training the parameters of an EBM using the DRL protocol such as described above. In some embodiments, the DRL protocol uses a total of T noise levels, where for a given t∈{0,1, . . . , T−1} noisy data with noise level t may be generated (e.g., xₜ given in equation 1.2) and sampled data

$${\tilde{y}}_{t , i} ∼ {p}_{θ} ( {y}_{t , i} \vert {x}_{t + 1 , i} ) ,$$

(equation 1.8) may be obtained, where the conditional distribution p_{θ}(y_{t,i}|x_{t+1,i}) is given by

$${p}_{θ} ( {y}_{t} \vert {x}_{t + 1} ) = \frac{1}{\tilde{Z} ( θ , {x}_{t + 1} )} exp ( - ( {ε}_{θ} ( {y}_{t} ; t ) + \frac{1}{2 {σ}_{t + 1}^{2}} {‖ {y}_{t} - {x}_{t + 1} ‖}^{2} ) ) ,$$

(equation 1.9). Given the gradient of the logarithm of the conditional distribution function with respect to input data,

$${∇}_{{y}_{t}} {ε}_{θ} ( {y}_{t} ; t ) + \frac{1}{{σ}_{t + 1}^{2}} ( {y}_{t} - {x}_{t + 1} ) ,$$

(equation 1.10) a Langevin MCMC algorithm may be used to obtain the desired sampled data \tilde{y}_{t,i}˜p_{θ}(y_{t,i}|x_{t+1,i}) as

$${y}_{t , i}^{( k + 1 )} = {y}_{t , i}^{( k )} - {δ}_{t} ( {∇}_{{y}_{t , i}^{( k )}} {ε}_{θ} ( {y}_{t , i}^{( k )} ; t ) + \frac{1}{{σ}_{t + 1}^{2}} ( {y}_{t , i}^{( k )} - {x}_{t + 1 , i} ) ) + \sqrt{2 {δ}_{t}} {ξ}_{k}$$

(equation 1.11) where ξₖ˜ [symbol] (0, l), δₜ is the Langevin MCMC step size for noise-level t
and the superscript k indicates the Langevin MCMC iteration step. Note that the a gradient of the deep EBM with respect to the synapse oscillators given the noisy observed data (∇_{θ}ε_{θ}(yₜ; t)) For example, sampled data \tilde{y}_{t,i} results from performing the Langevin MCMC iteration steps. For example, for a total of M iteration steps, the final iteration

$${y}_{t , i}^{( M )}$$

is used as the sampled data \tilde{y}_{t,i}. Thus, the sampled data (\tilde{y}ₜ) is generated using a plurality of Langevin Markov chain Monte Carlo (MCMC) sampling steps for the given noise level (t).

In equation 1.9, the energy function ε_{θ}(yₜ; t) may be intractable to implement directly in superconducting circuit based hardware, but may be implementable using the mean-field approach. That is, for a given noise-level t, there may be a sequence of K≥1 EBMs which may be defined as {ε_{θ}_{₁}(v₁|yₜ), . . . , ε_{θ}_{_{K}}(ν_{K}|w_{K-1})} during the forwards pass and the perturbed energy functions

$$\{ {\tilde{ε}}_{{θ}_{1}}^{( B )} ( {v}_{1} \vert {y}_{t} ) , … , {\tilde{ε}}_{{θ}_{K}}^{( B )} ( {v}_{K} \vert {w}_{K - 1} ) \}$$

during the backwards pass (e.g., the parameters are partitioned as θ=(θ₁, θ₂, . . . , θ_{K})), where to avoid confusion with the input xₜ₊₁ and output yₜ used in DRL, the variables w and v are used respectively for the inputs and outputs of the K EBMs used in the mean-field algorithm (for the very first EBM used to generate the samples via the mean-field approach at noise-level t, the input is labeled as yₜ).

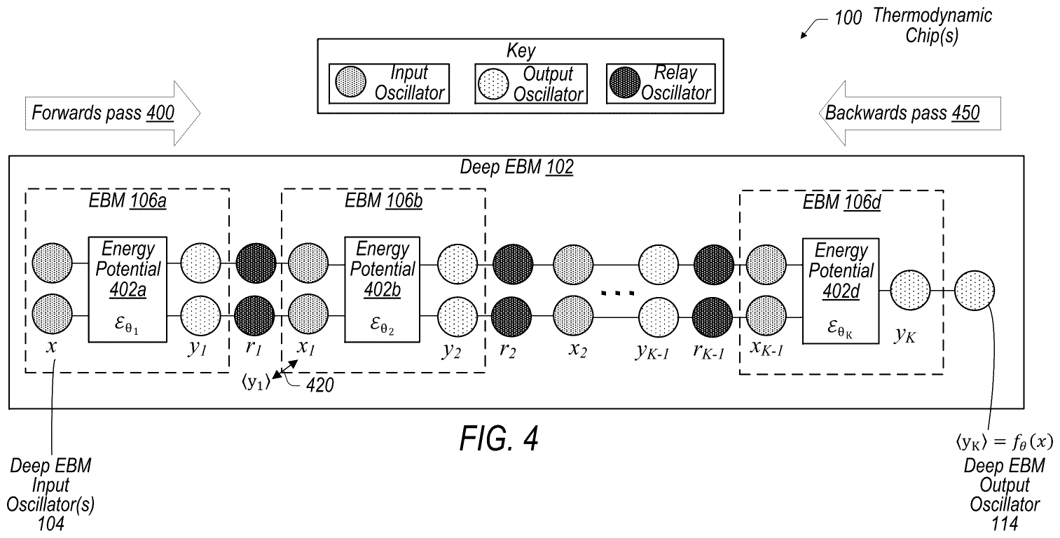

In some embodiments, an illustration of the EBMs used in the mean-field approach is shown in FIG. 4. Measurements of the averaged gradients of the energy functions are performed during the forward propagation step, and measurements of the averaged gradients of the perturbed energy functions are performed during the backwards propagation step. The gradient ∇_{y}_{_{t,i}}ε_{θ}(y_{t,i}; t) can then be computed on an external classical post-processing device using the chain rule as explained further below. Once the gradient is obtained, one Langevin MCMC step in equation 1.11 may be performed to obtain an updated sample y_{t,i}. The above may be repeated using the updated sample as the new input to the mean-field algorithm until the desired accuracy is achieved for sampled data \tilde{y}_{t,i}.

The above protocol can be performed to obtain samples at each noise-level t∈{0,1, . . . , T−1} as shown in FIG. 1D. For a given noise level, the parameters θ may be trained using equation 1.7 on an external classical post-processing device. The full protocol may be described as follows.

| | |
|---|---|
| 1: | Input: (1) Observed data x₀ ~ p_{data} (x); (2) Number of noise levels T; (3) Number of |

Langevin sampling steps M per noise level; (4) Langevin step size at each noise level δₜ;
(5) Learning rate η_{θ} for EBM ε_{θ}; (6) K ≥ 1 EBMs used for the mean-field algorithm at
each noise level;

| | |
|---|---|
| 2: | Output: Parameters θ. |
| 3: | Randomly initialize θ according to some prior distribution. |
| 4: | repeat |
| 5: | Sample noise level t from {0, 1, ... , T − 1}. Sample ϵ ~ [symbol] (0, I). |
| 6: | Compute n terms of the form x_{t+1,i} = α̅ₜ₊₁x_{0,i} + σ̅ₜ₊₁ϵ, y_{t,i} = α̅ₜ₊₁(α̅ₜx_{0,i} + σ̅ₜϵ) |
| | where i ∈ {1, 2, ··· , n}. |
| 7: | for k ← 0 to M − 1 do |
| 8: | $For all 1 \leq i \leq n , obtain the gradient {∇}_{{y}_{t , i}^{( k )}} {ℰ}_{θ} ( {y}_{t , i}^{( k )} ; t ) by using {y}_{t , i}^{( k )} ( with$ |
| | y_{t,i}⁽⁰⁾ = y_{t,i}) as the input to the mean-field algorithm of Ref., where the K |
| | $EMBs are chosen such that 〈 {v}_{K} 〉 = {ℰ}_{θ} ( {y}_{t , i}^{( k )} ; t ) .$ |
| 9: | $Update {y}_{t , i}^{( k + 1 )} using the gradient obtained in the previous step and equation$ |
| | 1.11 on an external classical post-processing device. |
| 10: | end for |
| 11: | Update the EBM parameters θ on an external classical post-processing device using |
| | $equation 1.7 and the samples {y}_{t , i}^{( M )} .$ |

12: until converged

Note that similar protocol may be performed for Denoising Diffusion Probabilistic Models. In general, having the ability to efficiently sample deep EBMs which can be emulated via a mean-field approach has its own benefits, for instance, in sampling from Neural Stochastic Differential Equations.

FIG. 1A is a high-level diagram illustrating one or more thermodynamic chips comprising oscillators, wherein the oscillators may thermodynamically evolve to obtain sample data and train parameters of an energy based model (EBM), according to some embodiments.

In some embodiments, thermodynamic chip(s) 100 may be used to implement energy based model (EBM) 106 or various other components of a thermodynamic computing system 117. Observed data generator 101 may be implemented using thermodynamic chips or by using classical computing devices or a combination of classical and thermodynamic parts. For example, observed data generator 101 may receive an input such as an image, video, audio, document, multi-media input, etc. based on a classical computing device representation of the input. Observed data generator may convert the input into thermodynamic information to be stored in a position or momentum degree of freedom of an oscillator. In some embodiments, observed data 103 may be represented by a classical computing device representation of the input. In some embodiments, observed data 103 may be represented by corresponding thermodynamic information. In some embodiments, observed data 103 may be stored as thermodynamic information of input oscillators.

In some embodiments, noise may be added to observed data 103 using noise generator 105. For example, there may be a given number of noise levels 107 to select from, or a user may indicate how many total noise levels 107 are to be considered. Noise level selector 109 may determine which noise level t to use for a given round of parameter updating. In some embodiments, each noise level may be used to iteratively update parameters of the energy function until the parameters are sufficiently converged to approximately stable values. In some embodiments, noise may be add to an image by adding a random noise values to pixel values of the image. In some embodiments, wherein the image is encoded in position or degrees of freedom of oscillators, noise may be thermodynamically added to the input by adding heat to the oscillators or allowing the oscillators to thermodynamically evolve or some combination of both. Thus, noisy observed data 111 may include classical representations of an input or thermodynamic representation of an input.

In some embodiments, noisy observed data 111 may be provided to deep EBM input oscillator(s) 104. At this step, the input to EBM 106 is encoded as position or momentum degrees of freedom of oscillators. Thus, EBM 106 may take advantage of thermodynamic evolution to evolve input thermodynamic data into output thermodynamic data which may reduce the energy required as compared to using classical computing devices. Deep EBM input oscillators 104 may be used as input to the energy function, wherein the energy function is implemented, thermodynamically, by EBM 106. EBM 106 may include oscillators 108 that represent synapses (e.g., weights and biases) and neurons of a neural network. For example, parameters of EBM 106 may include bias synapse oscillator 126, weight synapse oscillator 128, and weight synapse oscillator 130. Example hardware configurations of such oscillators are provided by FIGS. 5-7 and 12A-14. Deep EBM output gadget 113 may include configuration of oscillators similar to relay gadget 804 and be used to obtain the output of the energy function.

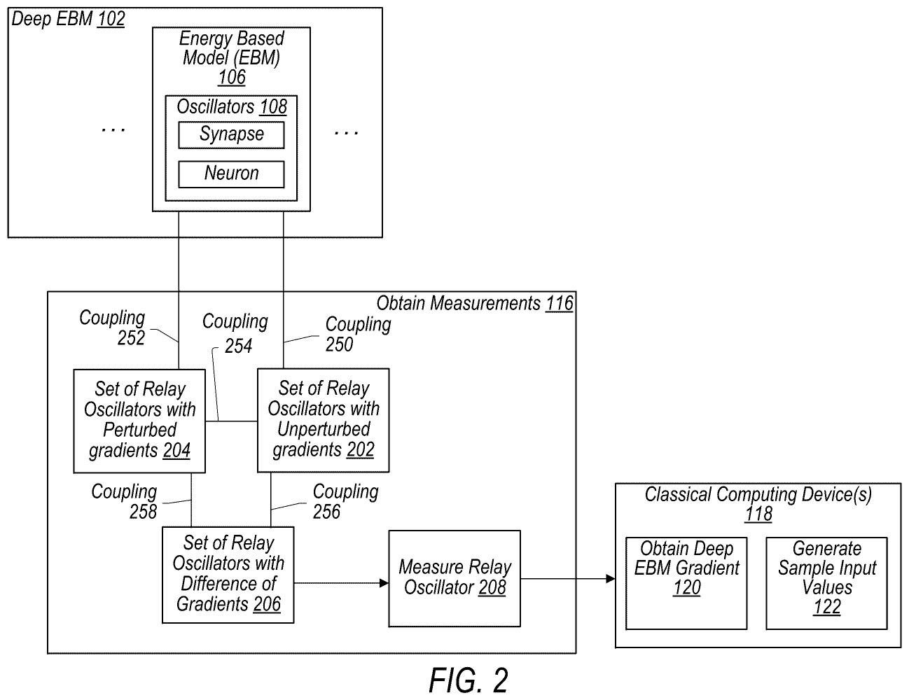

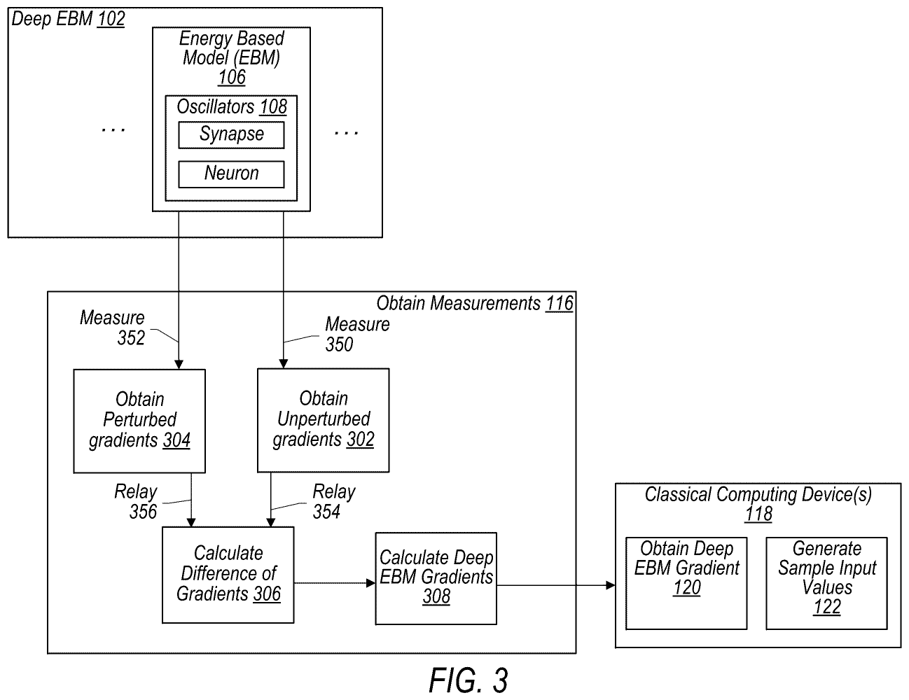

In some embodiments, obtain measurements 116 may be implemented such as shown in FIGS. 2-3. Generally, various oscillators may be configured to be measured such that thermodynamic information such as position or momentum degrees of freedom may be obtained. The thermodynamic information may be further processed by a classical computing device such as classical computing device(s) 118. For example, classical computing device(s) 118 may include input value sampler 115 to perform the classical calculations to determine sampled data.

FIG. 1B is a flowchart describing updating parameters of an energy based model (EBM) based on input including observed data, number of noise levels, number of Langevin sampling steps, Langevin step size at each noise level, and a learning rate, according to some embodiments.

At block 132, inputs are listed which may be used by a DRL engine to update synapse parameters. For example, inputs may include observed data, number of noise levels T, number of Langevin sampling steps K per noise level, Langevin step size at each noise level sₜ, and learning rate for an EBM. Parameters may also be initialized according to some prior probability distribution. For example, prior to causing the synapse oscillators, representing trainable parameters (θ), to be updated based on the noisy observed data and the sampled data, the synapse oscillators may be initialized to initial parameter values, wherein the initial parameter values are encoded in position degrees of freedom or momentum degrees of freedom of the synapse oscillators.

At block 134, noise generator 105 may be used to sample a noise level t from a set of noise levels, {0, 1, . . . , T−1}. At block 136, random variables may be sampled from a Gaussian distribution with mean zero, and the random variables may be added to the observed data to generate noisy data. Thus, noise may be added to observed data according to a given noise level (t), wherein the noisy observed data (yₜ) is used as input to the deep EBM. This may be performed classically or thermodynamically. At block 138, input data samples may be generated by running M steps of Langevin dynamics starting from the generated noisy data. At block 140, the samples may be used to update the EBM parameters. For examples, oscillators of the deep EBM may thermodynamically evolve to enable a gradient of the deep EBM with respect to the noisy observed data (∇_{y}_{ₜ}ε_{θ}(yₜ; t)) to be determined. The gradients of the EBM may be used such as described above to update the parameters. Thus, a gradient of the deep EBM with respect to the noisy observed data (∇_{y}_{ₜ}ε_{θ}(yₜ; t)) may be obtained. Sampled data (\tilde{y}ₜ) may be determined based on the gradient of the deep EBM (∇_{y}_{ₜ}ε_{θ}(yₜ; t)), wherein the sampled data (\tilde{y}ₜ) represents one or more instances of input data sampled from a distribution conditional to a higher noise level (\tilde{y}ₜ˜p_{θ}(yₜ|xₜ₊₁)). Synapse oscillators, representing trainable parameters (θ), may be updated based on the noisy observed data (yₜ) and the sampled data (\tilde{y}ₜ). Blocks 134 through 140 may be repeated a set number of times or until the parameters sufficiently converge to stable values (as indicated by parameters converged? 142).

FIG. 1C is a flowchart describing updating parameters of an energy based model (EBM) based on a plurality of Langevin sampling steps, according to some embodiments.

At block 144, inputs are listed which may be used by a DRL engine to update synapse parameters. For example, inputs may include observed data, number of noise levels T, number of Langevin sampling steps K per noise level, Langevin step size at each noise level dₜ, and learning rate for an EBM, and a deep EBM. Parameters may also be initialized according to some prior probability distribution.

At block 146, noise generator 105 may be used to sample a noise level t from a set of noise levels, {0, 1, . . . , T−1}. At block 148, random variables may be sampled from a Gaussian distribution with mean zero, and the random variables may be added to the observed data to generate noisy data. This may be performed classically or thermodynamically. At block 150, one or more gradients of the one or more EBMs (e.g., deep EBM) may be obtained using the plurality of noisy data as input to a mean-field algorithm. At block 152, a Langevin sampling step may be performed based on the gradients obtained. Blocks 150 and 152 may be repeated for each Langevin sampling step as indicated by “more Langevin sampling steps?” block 154. At block 156, the samples may be used to update the EBM parameters. For examples, gradients of the EBM may be determined such as described above to update the parameters. Blocks 146 through 156 may be repeated a set number of times or until the parameters sufficiently converge to stable values (as indicated by parameters converged? 158).

FIG. 1D is a high-level diagram illustrating architecture used to obtain sample data at each noise level, according to some embodiments.

In some embodiments, a mean field protocol is performed using thermodynamic chips for each noise level.

FIG. 1E is a high-level diagram illustrating a deep energy-based model (EBM) implemented on one or more thermodynamic chips, wherein a plurality of EBMs are implemented in hardware to implement the deep EBM, according to some embodiments.

In some embodiments, deep EBM 102 may be implemented on one or more thermodynamic chips 100. In some embodiments, a deep EBM 102 may have multiple blocks of smaller EBMs (e.g., EBM 106a, 106b, and 106c), where the output of a given EBM block l (by way of example, say EBM 106a is the EBM block l) is denoted by yₗ (which is encoded in the position degrees of freedom of the oscillators ϕ_{y}_{ₗ}). The output yₗ may be coupled to one or more relay oscillators such that the input for EBM block l+1 (e.g., EBM 106b) is ϕₓ_{ₗ}= [symbol] ϕ_{y}_{ₗ} [symbol] . In other words, the input to the EBM block l+1 (e.g., ϕₓ_{ₗ}) is the expectation value of the output of the previous block (e.g., [symbol] ϕ_{y}_{ₗ} [symbol] ). For notational simplicity, the input to the deep EBM 102 may be denoted as x, which is encoded in the position degrees of freedom of the oscillators ϕₓ (e.g., deep EBM input oscillator(s) 104). The energy function of the conditional EBM of block l (e.g., EBM 106a) may be denoted as ε_{θ}_{ₗ}(yₗ|xₗ₋₁). An EBM may be considered conditional wherein an input for the conditional EBM is based on output from another EBM. Furthermore, a deep EBM 102 may have a plurality of conditional EBMs (e.g., many blocks of EBMs). The total parameters of the deep EBM may be given by θ=(θ₁, . . . , θ_{K}) where θₗ are the parameters for the EBM in block l such as bias synapse oscillator 126, weight synapse oscillator 128 and weight synapse oscillator 130.

In some embodiments, a total of K≥1 EBM blocks may be used, and the output of the final EBM in block K may be y_{K} such that [symbol] y_{K} [symbol] =ƒ_{θ}(x). By way of example, EBM 106c may represent the final EBM in block K. Furthermore, a deep EBM is not constrained to three EBMs such as shown in FIG. 1. There may be any number of EBMs in a deep EBM to compute some function. In other words, the K EBM blocks may be used to compute some function ƒ_{θ}(x) using a mean-field approach, where the expectation value of the final output (e.g., deep EBM output oscillator 114) is equal to ƒ_{θ}(x), and where the inputs to each intermediate block is the expected value of the output of the previous EBM block (e.g., conditional EBMs).

In some embodiments, a deep EBM 102 may use mean-field forwards and backwards propagation steps to generate gradients used to sample input values x 122 using Langevin dynamics. For example, given a gradient with respect to input parameters x of a function implemented by the deep EBM (e.g., ∇ₓƒ_{θ}(x), which may also be referred to as deep EBM gradients for simplicity), an input x may may be sampled from an underlying distribution, wherein the underlying distribution may be represented by

$$x ∼ {p}_{θ} ( x ) = \frac{{e}^{- {f}_{θ} ( x )}}{Z ( θ )} ,$$

using a Langevin Markov chain Monte Carlo (MCMC) algorithm as

$${x}_{k + 1} = {x}_{k} - δ {∇}_{x} {f}_{θ} ( x ) + \sqrt{2 δ} {ξ}_{k} ,$$

(equation 2.1) where ξₖ˜ [symbol] (0,l). In equation 2.1, the subscripts k and k+1 may indicate the Langevin MCMC step, and δ may be the step size. Following equation 2.1, it may be desirable to obtain the deep EBM gradient 120 ∇ₓƒ_{θ}(x) using mean-field forwards and backwards approaches. Note that equations 2.1-2.26 reuse symbols that may have different definitions as compared to the definition of symbols in equations 1.1-1.11.

### Forwards Pass

As will be shown below for a backwards pass, the back-propagation step used to compute the gradient ∇ₓƒ_{θ}(x) (e.g., obtain deep EBM gradient 120) requires gradients of the form

$${𝔼 [ \frac{\partial {ε}_{{θ}_{l}} ( {y}_{l} \vert {x}_{l - 1} )}{\partial 〈 {y}_{l - 1}^{( j )} 〉} ]}_{{y}_{l} ∼ {p}_{{θ}_{l}} ( {y}_{l} \vert {x}_{l - 1} )} = {𝔼 [ \frac{\partial {ε}_{{θ}_{l}} ( {y}_{l} \vert {x}_{l - 1} )}{\partial {x}_{l - I}^{( j )}} ]}_{{y}_{l} ∼ {{p}_{θ}}_{l} ( {y}_{l} \vert {x}_{l - 1} )} ,$$

(equation 2.2). Such gradients of equation 2.2 (which may be referred to as gradients of an EBM with an unperturbed potential) may be stored in the position degrees of freedom of relay oscillators for all EBM blocks 1≤l≤K. Alternatively, oscillators of respective EBMs may be measured, wherein the measurements are stored on a classical computer and the gradients of the respective EBMs with an unperturbed potential may be calculated. Nevertheless, in the embodiments where relay oscillators are used to store gradients,

$${ϕ}_{{r}_{1}}^{( l , j )}$$

may be defined as a relay oscillator in a first set of relay oscillators whose position degree of freedom is static at the gradient given in equation 2.2.

### Backwards Pass

As discussed above, it may be desirable to compute gradients of the form

$$\frac{\partial {f}_{θ} ( x )}{\partial {x}^{( j )}} = \frac{\partial 〈 {y}_{K} 〉}{\partial {x}^{( j )}}$$

(equation 2.3) for all indices j spanning the size of the input vector x (e.g., there may be a plurality of inputs collectively represented as x). Using the chain rule may result in the following

$$\frac{\partial 〈 {y}_{K} 〉}{\partial {x}^{( j )}} = {\sum }_{{s}_{1} ∈ {𝒥}_{j}^{( 1 )}} \frac{\partial 〈 {y}_{K} 〉}{\partial 〈 {y}_{1}^{( {s}_{1} )} 〉} \frac{\partial 〈 {y}_{1}^{( {s}_{1} )} 〉}{\partial {x}^{( j )}} \\ \frac{\partial 〈 {y}_{K} 〉}{\partial 〈 {y}_{1}^{( {s}_{1} )} 〉} = {\sum }_{{s}_{2} ∈ {𝒥}_{{s}_{1}}^{( 2 )}} \frac{\partial 〈 {y}_{K} 〉}{\partial 〈 {y}_{2}^{( {s}_{2} )} 〉} \frac{\partial 〈 {y}_{2}^{( {s}_{2} )} 〉}{\partial 〈 {y}_{1}^{( {s}_{1} )} 〉}$$

(equation 2.4 and equation 2.5) up to

$$\frac{\partial 〈 {y}_{K} 〉}{\partial 〈 {y}_{K - 2}^{( {s}_{K - 2} )} 〉} = {\sum }_{{s}_{K - 1} ∈ {𝒥}_{{s}_{K - 2}}^{( K - 1 )}} \frac{\partial 〈 {y}_{K} 〉}{\partial 〈 {y}_{K - 1}^{( {s}_{K - 1} )} 〉} \frac{\partial 〈 {y}_{K - 1}^{( {s}_{K - 1} )} 〉}{\partial 〈 {y}_{K - 2}^{( {s}_{K - 2} )} 〉}$$

(equation 2.6) and where s∈

$${𝒥}_{j}^{( l )}$$

may include all indices for which the output nodes

$${y}_{l + 1}^{( s )}$$

of a next block are coupled to

$${y}_{l}^{( j )}$$

of a given block. Around the discussion of equation 2.26 it is shown that

$$\frac{\partial 〈 {y}_{l + 1}^{( s )} 〉}{\partial 〈 {y}_{l}^{0 )} 〉} = - {Cov ( {y}_{l + 1}^{( s )} , \frac{\partial {ε}_{{θ}_{l + 1}} ( {y}_{l + 1} \vert 〈 {y}_{l} 〉 )}{\partial 〈 {y}_{l}^{( j )} 〉} )}_{{y}_{l + 1}^{( s )} ∼ {p}_{{θ}_{l + 1}} ( {y}_{l + 1} \vert 〈 {y}_{l} 〉 )} ,$$

(equation 2.7). For a backwards pass, energy functions of the EBMs may be perturbed. A perturbed energy function during the back-propagation step may be given as

$${\tilde{ε}}_{{θ}_{l}}^{( B )} ( {y}_{l} \vert 〈 {y}_{l - 1} 〉 ) = {ε}_{{θ}_{l}} ( {y}_{l} \vert 〈 {y}_{l - 1} 〉 ) + ϵ \tilde{V} ( {y}_{l} ) ,$$

(equation 2.8) for ϵ«1. Now using a mean-field relay oscillator method to store space averaged gradients in the position degrees of freedom of relay oscillators, let

$${ϕ}_{{r}_{2}}^{( l , j )}$$

be a relay oscillator of a second set of relay oscillators whose position degree of freedom is static at the gradient

$${I}_{2}^{( l , j )} ,$$

where

$${I}_{2}^{( l , j )}$$

is defined as

$${𝔼 [ \frac{\partial {\tilde{ε}}_{{θ}_{l}}^{( B )} ( {y}_{l} \vert 〈 {y}_{l - 1} 〉 )}{\partial 〈 {y}_{l - 1}^{( j )} 〉} ]}_{{y}_{l} ∼ {{p}_{θ}}_{l} ( {y}_{l} \vert {x}_{l - 1} )} = \int {d y}_{l} \frac{\partial {\tilde{ε}}_{{θ}_{l}}^{( B )} ( {y}_{l} - \vert 〈 {y}_{l - 1} 〉 )}{\partial 〈 {y}_{l - 1}^{( j )} 〉} \frac{{e}^{- {ε}_{{θ}_{ι}} ( {y}_{l} \vert 〈 {y}_{l - 1} 〉 ) - ϵ \tilde{V} ( {y}_{l} )}}{{\tilde{Z}}^{( B )}} ≡ {I}_{2}^{( l , j )} ,$$

(equation 2.9). Taylor expanding equation 2.9 and keeping terms to leading order in ϵ, may result in

$${I}_{2}^{( l , j )} = \{ \frac{\partial {ε}_{{θ}_{l}} ( {y}_{l} \vert 〈 {y}_{l - 1} 〉 )}{\partial 〈 {y}_{l - 1}^{( j )} 〉} \} - ϵ Cov ( \tilde{V} ( {y}_{l} ) , \frac{\partial {ε}_{{θ}_{l}} ( {y}_{l} - \vert 〈 {y}_{l - 1} 〉 )}{\partial 〈 {y}_{l - 1}^{( J )} 〉} ) + 𝒪 ( {ϵ}^{2} ) ,$$

(equation 2.10). Now, according to some embodiments, a perturbed potential \tilde{V}(yₗ), such as in equation 2.8, may be set as

$$\tilde{V} ( {y}_{l} ) = \frac{\partial 〈 {y}_{K} 〉}{\partial 〈 {y}_{l} 〉} \cdot {y}_{l} ,$$

(equation 2.11) if l<K and \tilde{V}(y_{K})=y_{K} for l=K. Inserting equation 2.11 into equation 2.10 may result in

$$\begin{matrix}{I}_{2}^{( l , j )} - \{ \frac{\partial {ε}_{{θ}_{l}} ( {y}_{l} - \vert 〈 {y}_{l - 1} 〉 )}{\partial 〈 {y}_{l - 1}^{( j )} 〉} \} = - ϵ \frac{\partial 〈 {y}_{K} 〉}{\partial 〈 {y}_{l} 〉} \cdot Cov ( {y}_{l} , \frac{\partial {ε}_{{θ}_{l}} ( {y}_{l} \vert 〈 {y}_{l - 1} 〉 )}{\partial 〈 {y}_{l - 1}^{( j )} 〉} ) + 𝒪 ( {ϵ}^{2} ) \\ = ∈ {\sum }_{s ∈ {J}_{j}^{( l - 1 )}} \frac{\partial 〈 {y}_{K} 〉 \partial 〈 {y}_{l}^{( s )} 〉}{\partial 〈 {y}_{l}^{( s )} 〉 \partial 〈 {y}_{l - 1}^{( j )} 〉} + 𝒪 ( {ϵ}^{2} ) \\ = ϵ \frac{\partial 〈 {y}_{K} 〉}{\partial 〈 {y}_{l - 1}^{( j )} 〉} + 𝒪 ( {ϵ}^{2} ) ,\end{matrix}$$

(equation 2.12) which (up to the E pre-factor) is the desired gradient for EBM block l.

Utilizing the result leading to equation 2.12, a third relay oscillator

$${ϕ}_{{r}_{3}}^{( l , j )}$$

of a set of relay oscillators is introduced with mass m_{ƒ} and frequency ω_{ƒ} which is coupled to relay oscillators

$${ϕ}_{{γ}_{1}}^{( l , j )} and {ϕ}_{{r}_{2}}^{( l , j )}$$

using the potential

$${V}_{B K M}^{( 3 )} = \frac{1}{2} {m}_{f} {{ω}_{f}^{2} ( {ϕ}_{{r}_{3}}^{( l , j )} )}^{2} + {λ}_{3} ( t ) {( {ϕ}_{{r}_{3}}^{( l , j )} - {c}_{1} ( {ϕ}_{{r}_{2}}^{( l , j )} - {ϕ}_{{r}_{1}}^{( l , j )} ) )}^{2} .$$

(equation 2.13). Note that relay oscillator

$${ϕ}_{{r}_{1}}^{( l , j )}$$

is static according to equation 2.2 and

$${ϕ}_{{r}_{2}}^{( l , j )}$$

is static according to equation 2.9. By setting the coupling coefficient λ₃ to

$${λ}_{3} ≫ \frac{1}{2} {m}_{f} {ω}_{f}^{2} ,$$

(equation 2.14) in equation 2.13 and the coupling constant c₁=1/ϵ, and following equation 2.12, relay oscillator

$${ϕ}_{{r}_{3}}^{( l , j )}$$

reaches equilibrium at

$$\frac{\partial 〈 {y}_{K} 〉}{\partial 〈 {y}_{l - 1}^{( j )} 〉} ,$$

according to some embodiments. Relay oscillator

$${ϕ}_{{r}_{3}}^{( l , j )}$$

may then be coupled to yₗ to create the perturbed potential \tilde{V}(yₗ) in equation 2.11. By utilizing such couplings, the gradients

$${I}_{2}^{( l - 1 , j )}$$

for the EBM in block l−1 may be computed. Continuing this way until l=1, the position degrees of freedom of the relay oscillators

$${ϕ}_{{r}_{3}}^{( 1 , j )}$$

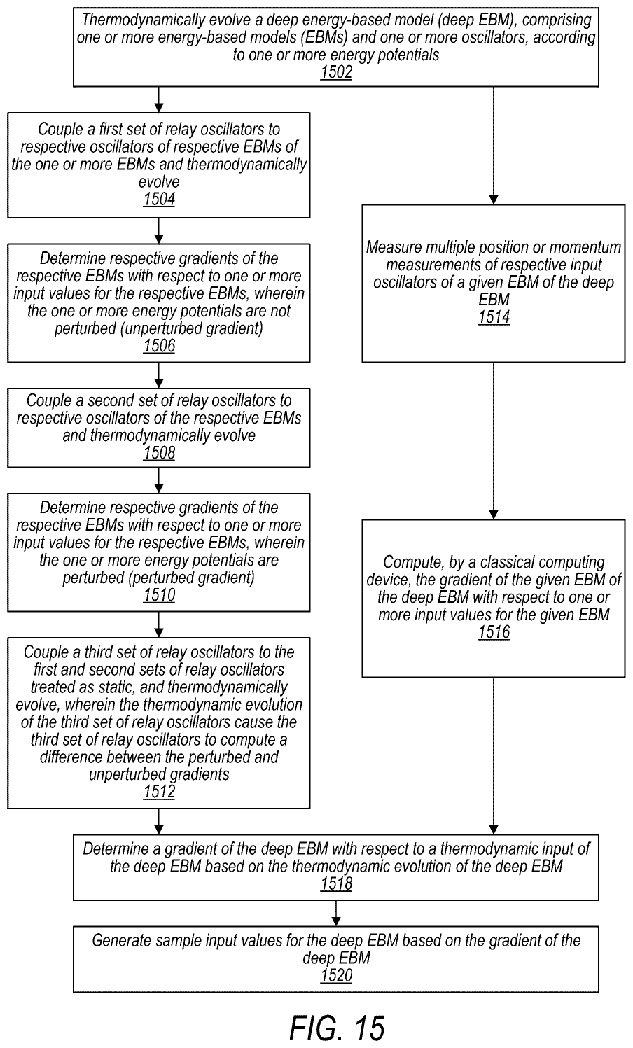

will be static at the gradients in equation 2.3, according to some embodiments. See FIG. 15. By measuring the position degrees of freedom of

$${ϕ}_{{r}_{3}}^{( 1 , j )}$$

for all indices j and sending the measurement results to a classical computing device(s) 118 (e.g., an external classical post-processing device), such a device will then contain the gradient of the deep EBM, ∇ₓƒ_{θ}(x). Similarly, the gradient of the deep EBM with respect to the instance of noisy observed data (∇_{y}_{_{t,i}}ε_{θ}(y_{t,i}; t)) may be obtained.

FIG. 2 is a high-level diagram illustrating sets of relay oscillators configured to be coupled to oscillators of a deep energy-based model (deep EBM), wherein the coupling enables gradient terms to be obtained to emulate deep neural diffusion of a deep EBM, according to some embodiments.

In some embodiments, an example of hardware and a process for a time-scale separated fully programmable deep neural diffusion backwards propagation (such as described above) may be described as follows.

Let

$${ϕ}_{{r}_{1}}^{( l , j )}$$

be a relay oscillator of a first set of relay oscillators whose position degree of freedom is static at the gradient

$$〈 \frac{\partial {ℰ}_{{θ}_{l}} ( {y}_{l} \vert {x}_{l} )}{\partial 〈 {y}_{l - 1}^{( j )} 〉} 〉$$

obtained during a forwards pass (e.g., set of relay oscillators with unperturbed gradients 202). Such relay oscillators exist in the first set of relay oscillators for each 1≤l≤K (and each index j for a given layer). Coupling 250 may enable the set of relay oscillators with unperturbed gradients 202 to obtain the perturbed gradients.

Backwards pass: Let

$${\tilde{ℰ}}_{{θ}_{l}}^{( B )} ( {y}_{l} \vert 〈 {y}_{l - 1} 〉 )$$

be the potential energy used for EBM block l given in equation 2.8.

For each block l of block K to block 1, the following steps may be performed.

Step 1: If l=K, set \tilde{V}(y_{K})=y_{K}. Otherwise set

$$\tilde{V} ( {y}_{l} ) = \frac{\partial 〈 {y}_{K} 〉}{\partial 〈 {y}_{l} 〉} \cdot {y}_{l} ,$$

where the vector

$$\frac{\partial 〈 {y}_{K} 〉}{\partial 〈 {y}_{l} 〉}$$

is encoded in the position degree of freedom of the relay oscillators

$${ϕ}_{{r}_{3}}^{( l + 1 , j )}$$

computed in the previous block (e.g., set of relay oscillators with difference of gradients 206). In this case, \tilde{V}(yₗ) is set by coupling

$${ϕ}_{{r}_{3}}^{( l + 1 , j )} to {y}_{l}^{( j )} .$$

Step 2: Use a mean-field relay oscillator method such that the relay oscillators with position degree of freedom

$${ϕ}_{{r}_{2}}^{( l , j )}$$

(set of relay oscillators with perturbed gradients 204) remains static at

$${E [ \frac{\partial {\tilde{ε}}_{{θ}_{l}}^{( B )} ( {y}_{l} \vert 〈 {y}_{l - 1} 〉 )}{\partial \{ {y}_{l - 1}^{( j )} \}} ]}_{{y}_{l} ∼ {p}_{{θ}_{l}} ( {y}_{l} \vert {x}_{l - 1} )} .$$

Step 3: Couple a third batch of relay oscillators

$${ϕ}_{{r}_{3}}^{( l , j )}$$

(for each j) with masses m_{ƒ} and frequencies ω_{ƒ} to

$${ϕ}_{{r}_{2}}^{( l , j )} and {ϕ}_{{r}_{1}}^{( l , j )}$$

as in equation 2.13 (with

$${ϕ}_{{r}_{2}}^{( l , j )} and {ϕ}_{{r}_{1}}^{( l , j )}$$

treated as static) and where the coupling term is

$${λ}_{3} ( t ) {( {ϕ}_{{r}_{3}}^{( l , j )} - {c}_{1} ( {ϕ}_{{r}_{2}}^{( l , j )} - {ϕ}_{{r}_{1}}^{( l , j )} ) )}^{2} .$$

Step 4: Set

$${λ}_{3} ≫ \frac{1}{2} {m}_{f} {ω}_{f}^{2}$$

and c₁=1/ϵ. Tune the product

$${m}_{f} {ω}_{f}^{2}$$

such that the position degree of freedom of

$${ϕ}_{{r}_{3}}^{( l , j )}$$

remains static at

$$\frac{\partial 〈 {y}_{K} 〉}{\partial 〈 {y}_{l - 1}^{( j )} 〉} .$$

With the steps above performed for each block l of block K to block 1, the system may measure the position degrees of freedom of the relay oscillators

$${ϕ}_{{r}_{3}}^{( l , j )}$$

for each j (where j spans the size of the input vector x). Such measurements correspond to the desired gradients in equation 2.3, the deep EBM gradients.

Send the measurement results to an external classical post-processing device.

### Calculation of the Gradient of the Loss Function for Mean-Field Deep EBMs

According to some embodiments, a detailed calculation of relevant gradients needed to perform the backwards propagation may be described as follows, starting with

$$\frac{\partial 〈 {y}_{l} 〉}{\partial {θ}_{l}^{( j )}} .$$

Using the definition of an expectation value results in

$$\frac{\partial 〈 {y}_{l} 〉}{\partial {θ}_{l}^{( j )}} = \int {dy}_{l} {y}_{l} \frac{\partial }{\partial {θ}_{l}^{( j )}} p ( {y}_{l} \vert {θ}_{l} , {x}_{l - 1} )$$

(equation 2.15). Using the definition of the probability distribution for conditional EBMs may result in

$$\begin{matrix}\frac{\partial }{\partial {θ}_{l}^{( j )}} p ( {y}_{l} \vert {θ}_{l} , {x}_{l - 1} ) = \frac{\partial }{\partial {θ}_{l}^{( j )}} \frac{{e}^{- {ℰ}_{{θ}_{l}} ( {y}_{l} \vert {x}_{l - 1} )}}{Z ( {X}_{l - 1} , {θ}_{l} )} \\ = - p ( {y}_{l} \vert {x}_{l - 1} ) \frac{\partial {ℰ}_{{θ}_{l}} ( {y}_{l} \vert {x}_{l - 1} )}{\partial {θ}_{l}^{( j )}} - \frac{{e}^{- {ℰ}_{{θ}_{l}} ( {y}_{l} \vert {x}_{l - 1} )}}{Z ( {X}_{l - 1} , {θ}_{l} )} \frac{\partial Z ( {x}_{l - 1} , {θ}_{l} )}{\partial {θ}_{l}^{( j )}} \\ = - p ( {y}_{l} \vert {x}_{l - 1} ) ( \frac{\partial {ℰ}_{{θ}_{l}} ( {y}_{l} \vert {x}_{l - 1} )}{\partial {θ}_{l}^{( j )}} + \frac{1}{Z ( {x}_{l - 1} , {θ}_{l} )} \frac{\partial Z ( {x}_{l - 1} , {θ}_{l} )}{\partial {θ}_{l}^{( j )}} )\end{matrix}$$

(equation 2.16). Now, it may follow that

$$\begin{matrix}\frac{\partial Z ( {x}_{l - 1} , {θ}_{l} )}{\partial {θ}_{l}^{( j )}} = \int dy \frac{{e}^{- {ℰ}_{{θ}_{l}} ( {y}_{l} \vert {x}_{l - 1} )}}{\partial {θ}_{l}^{( j )}} \\ = - \int dy \frac{\partial {ℰ}_{{θ}_{l}} ( {y}_{l} \vert {x}_{l - 1} )}{\partial {θ}_{l}^{( j )}} {e}^{- {ℰ}_{{θ}_{l}} ( {y}_{l} \vert {x}_{l - 1} )} ,\end{matrix}$$

(equation 2.17) so that equation 2.16 becomes

$$\frac{\partial }{\partial {θ}_{l}^{( j )}} p ( {y}_{l} \vert {θ}_{l} , {x}_{l - 1} ) = - p ( {y}_{l} \vert {θ}_{l} , {x}_{l - 1} ) ( \frac{\partial {ℰ}_{{θ}_{l}} ( {y}_{l} \vert {x}_{l - 1} )}{\partial {θ}_{l}^{( j )}} - {〈 \frac{\partial {ℰ}_{{θ}_{l}} ( {y}_{l} \vert {x}_{l - 1} )}{\partial {θ}_{l}^{( j )}} 〉}_{p ( {y}_{l} \vert {θ}_{l} , {x}_{l - 1} )} ) ,$$

(equation 2.18). Inserting equation 2.18 into equation 2.15 may result in

$$\frac{\partial 〈 {y}_{l} 〉}{\partial {θ}_{l}^{( j )}} = - \int {dy}_{l} {y}_{l} \frac{\partial {ℰ}_{{θ}_{l}} ( {y}_{l} \vert {x}_{l - 1} )}{\partial {θ}_{l}^{( j )}} p ( {y}_{l} \vert {θ}_{l} , {x}_{l - 1} ) + \int {dy}_{l}^{( t )} {y}_{l} p ( {y}_{l} \vert {θ}_{l} , {x}_{l - 1} ) {〈 \frac{\partial {ℰ}_{{θ}_{l}} ( {y}_{l} \vert {x}_{l - 1} )}{\partial {θ}_{l}^{( j )}} 〉}_{p ( {y}_{l} \vert {θ}_{l} , {x}_{l - 1} )} = - {〈 {y}_{l} \frac{\partial {ℰ}_{{θ}_{l}} ( {y}_{l} \vert {x}_{l - 1} )}{\partial {θ}_{l}^{( j )}} 〉}_{p ( {y}_{l} \vert {θ}_{l} , {x}_{l - 1} )} + {〈 {y}_{l} 〉}_{p ( {y}_{l} \vert {θ}_{l} , {x}_{l - 1} )} {〈 \frac{\partial {ℰ}_{{θ}_{l}} ( {y}_{l} \vert {x}_{l - 1} )}{\partial {θ}_{l}^{( j )}} 〉}_{p ( {y}_{l} \vert {θ}_{l} , {x}_{l - 1} )} = - Cov ( {y}_{l} , \frac{\partial {ℰ}_{{θ}_{l}} ( {y}_{l} \vert {x}_{l - 1} )}{\partial {θ}_{l}^{( j )}} ) ,$$

(equation 2.19) where the covariance of two random variables X and Y is defined as

$$Cov ( X , Y ) = 〈 XY 〉 - 〈 X 〉 〈 Y 〉 ,$$

(equation 2.20). Therefore, the term

$$\frac{\partial 〈 {y}_{l} 〉}{\partial {θ}_{l}^{( j )}}$$

can be obtained by computing the covariance between the output of the EBM in layer l and the gradient of the corresponding potential energy with respect to the parameters.

Now computing the term

$$\frac{\partial L}{\partial 〈 {y}_{l}^{( j )} 〉}$$

(where without loss of generality the index i is removed) is discussed. Some embodiments may start with the final layer, and then consider the hidden layers of the deep neural network. For the final layer, using

$${L}_{i} = \frac{1}{2} {( {y}_{i}^{( t )} - 〈 {y}_{K}^{( i )} 〉 )}^{2} ,$$

(equation 2.21) may result in

$$\frac{\partial L}{\partial 〈 {y}_{K}^{( 1 )} 〉} = - ( {y}^{( t )} - 〈 {y}_{K} 〉 ) ,$$

(equation 2.22) where the superscript index is removed in [symbol] y_{K} [symbol] since models with a single output in the final layer is considered, according to some embodiments. For the hidden layer, the chain rule may be used to result in

$$\frac{\partial L}{\partial 〈 {y}_{l}^{( j )} 〉} = {\sum }_{s ∈ {J}_{j}^{( l )}} \frac{\partial L}{\partial 〈 {y}_{l + 1}^{( s )} 〉} \frac{\partial 〈 {y}_{l + 1}^{( s )} 〉}{\partial 〈 {y}_{l}^{( j )} 〉} ,$$

(equation 2.23) where the set

$${J}_{j}^{( l )} \qquad ( l )$$

includes all indices for which the output nodes

$${y}_{l + 1}^{( s )}$$

are coupled to

$${x}_{l}^{( j )} = 〈 {y}_{l}^{( j )} 〉 .$$

The second term on the right-hand side of equation 2.23 is computed as follows. First the derivative of the expectation value may be expressed explicitly as

$$\frac{\partial 〈 {y}_{l + 1}^{( s )} 〉}{\partial 〈 {y}_{l}^{( j )} 〉} = \int d {y}_{l + 1}^{( s )} {y}_{l + 1}^{( s )} \frac{\partial }{\partial 〈 {y}_{l}^{( j )} 〉} \frac{{e}^{- {ε}_{{θ}_{l + 1}} ( {y}_{l + 1} \vert 〈 {y}_{l} 〉 )}}{Z ( 〈 {y}_{l} 〉 , {θ}_{l + 1} )} ,$$

(equation 2.24). Importantly, note that the input to the EBM block in layer l+1 is xₗ= [symbol] yₗ [symbol] since the rely oscillator imparts its state to xₗ. Thus, xₗ may be replaced with [symbol] yₗ [symbol] in equation 2.24. Now, computing the derivative inequation 2.24 may result in

$$\frac{\partial }{\partial 〈 {y}_{l}^{( j )} 〉} \frac{{e}^{- {ε}_{{θ}_{l + 1}} ( {y}_{l + 1} \vert 〈 {y}_{l} 〉 )}}{Z ( 〈 {y}_{l} 〉 , {θ}_{l + 1} )} = - p ( {y}_{l + 1} \vert 〈 {y}_{l} 〉 , {θ}_{l + 1} ) ( \frac{\partial {ε}_{{θ}_{l + 1}} ( {y}_{l + 1} \vert 〈 {y}_{l} 〉 )}{\partial 〈 {y}_{l}^{( j )} 〉} - 〈 \frac{\partial {ε}_{{θ}_{l + 1}} ( {y}_{l + 1} \vert 〈 {y}_{l} 〉 )}{\partial 〈 {y}_{l}^{( j )} 〉} 〉 ) ,$$

(equation 2.25). Inserting equation 2.25 into equation 2.24 may result in

$$\frac{\partial 〈 {y}_{l + 1}^{( s )} 〉}{\partial 〈 {y}_{l}^{( j )} 〉} = - Cov ( {y}_{l + 1}^{( s )} , \frac{\partial {ε}_{{θ}_{l + 1}} ( {y}_{l + 1} \vert 〈 {y}_{l} 〉 )}{\partial 〈 {y}_{l}^{( j )} 〉} ) ,$$

(equation 2.26) where similar methods that went into deriving equation 2.19 are used.

FIG. 3 is a high-level diagram illustrating oscillators of a deep energy-based model (deep EBM) configured to be measured, wherein the measurements enable gradient terms to be obtained to emulate deep neural diffusion of a deep EBM, according to some embodiments.

In some embodiments, EBMs 106 of the deep EBM may have oscillators 108 that are configured to be measured. For example, measurements of input or output neuron oscillators may be used to determine gradients and differences of gradients. Measure 350 may indicate measurements of neuron oscillators, wherein the measurements are used to obtain perturbed gradients 302. Measure 352 may indicate measurements of neuron oscillators, wherein the measurements are used to obtain unperturbed gradients 304. The unperturbed and perturbed gradients may be calculated on a classical computing device and based on the measurements. With the gradients obtained and calculated, the gradients may be relayed to a classical computing device as illustrated by relay 356 and 354. Then the classical computing device may calculate a difference of gradients 306. The difference of gradients may be used to calculate deep EBM gradients 308.

FIG. 4 is a high-level diagram illustrating a deep energy-based model (EBM), which may be used to sample input values, according to some embodiments.

In some embodiments, a deep energy-based model (EBM) may emulate deep neural diffusion using a mean-field forwards (e.g., forwards pass 400) and backwards propagation (e.g., backwards pass 450) method. For example, the expectation value of the output of a given EBM block (e.g., EBM 106a) may be used as an input to the next block (EBM 106b). The parameters (e.g., synapses of oscillators 108a-c such as weights and biases) of energy potentials 402a-d may be fixed. Gradients of the energy function in each EBM block 102a-d may be stored in the position degrees of freedom of one or more relay oscillators using a mean-field relay oscillator protocol during both the forwards (400) and backwards (450) pass. However, during the backwards pass 450, a perturbation to the energy potential 402a-d in each EBM block 106a-d may be turned on. The perturbed potential may be achieved through a linear coupling between relay oscillators that encode the relevant gradients and output neurons of the EBM blocks.

In some embodiments, a deep EBM may have deep EBM input oscillator(s) 104 as part of a first EBM block such as EBM 106a. Thermodynamic information may be processed from one EBM to the next, wherein a deep EBM output oscillator 114 encodes an output of a function implemented by the deep EBM. As illustrated by 420, the input of an EBM may be the expected value of an output oscillator of a previous EBM.

FIG. 5 is a diagram illustrating hardware components that may be used to implement oscillators of energy-based models (EBMs), as well as two different example hardware configurations of a relay oscillator that have a time-dependent mass or a time-dependent frequency, respectively, according to some embodiments.

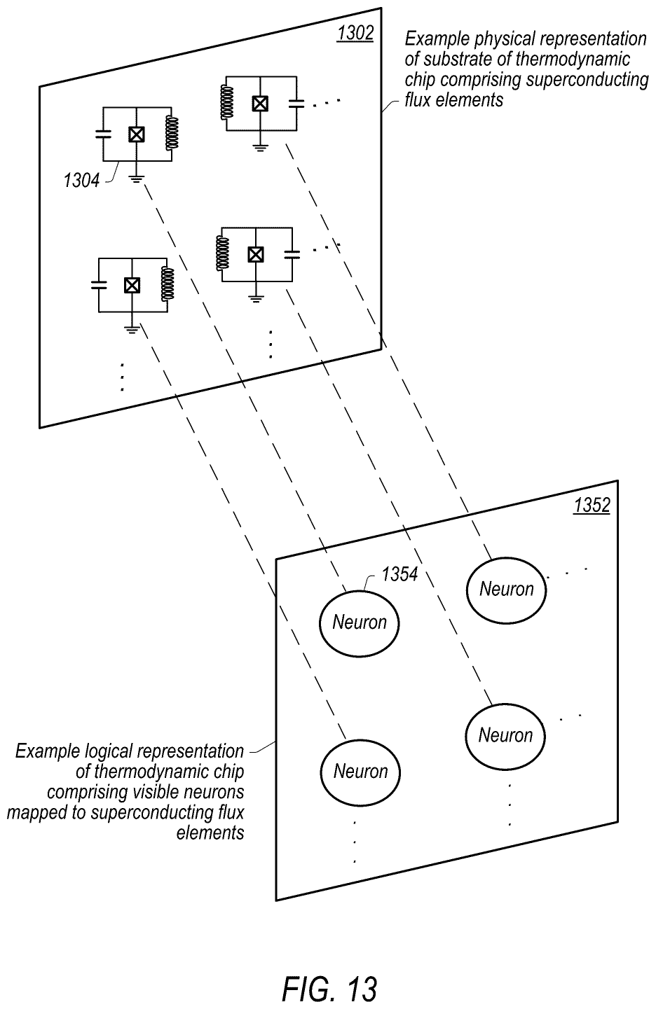

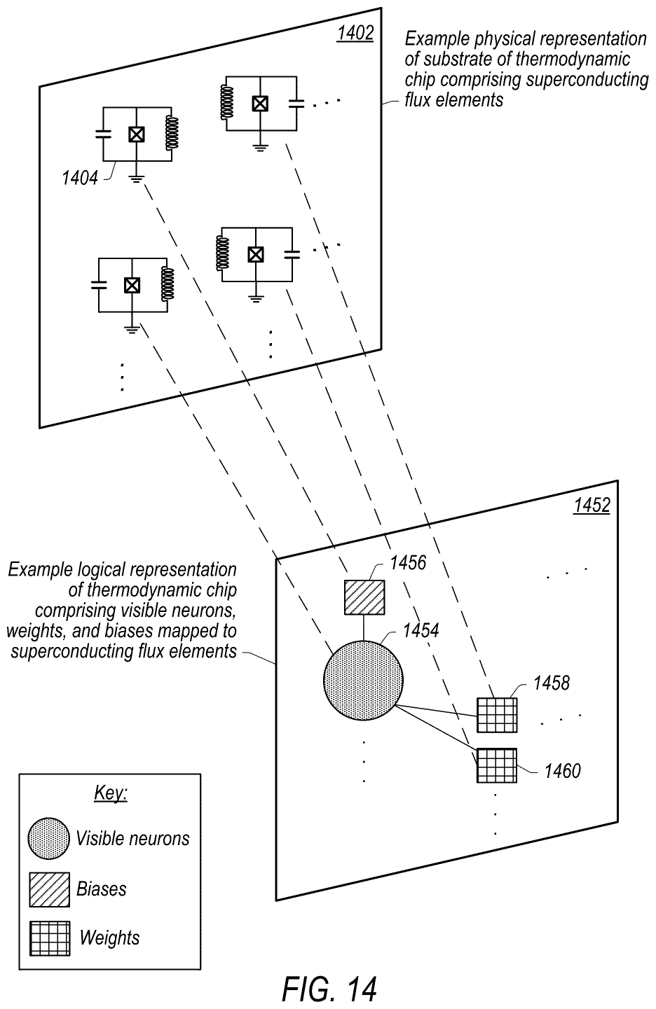

In some embodiments, each of the oscillators of the first energy-based model 106a and the second energy-based model 106b, may be implemented using superconducting circuit elements, such as shown in FIG. 5. These superconducting circuit elements may be used to implement oscillators that are mapped to visible or hidden neurons of the first or second energy-based model (e.g., 108a and 104b). Also, such oscillators may be mapped to synapses (e.g. weights or biases) of the first or second energy-based model. FIGS. 13-14 provide additional details regarding the mappings and hardware configurations used to implement example energy-based models. Also, as shown in FIG. 5 superconducting circuit elements may be used to implement the bias oscillator 506.

However, slightly different superconducting circuits may be used to implement the relay oscillator. In some embodiments a relay gadget 110a or 110b may comprise a plurality of relay oscillators such as relay oscillator 112a, wherein an expectation value of output oscillator 510 may be relayed to input oscillator 512. For example, circuit 502 shows an example implementation circuit for the relay oscillator 112a, wherein the circuit 502 implements a time-dependent frequency that can be controlled by controller 508. As another alternative, circuit 504 shows an example implementation circuit for the relay oscillator 112a, wherein the circuit 504 implements a time-dependent mass that can be controlled by controller 508.

In some embodiments, the relay gadget does not include a bias oscillator 506.

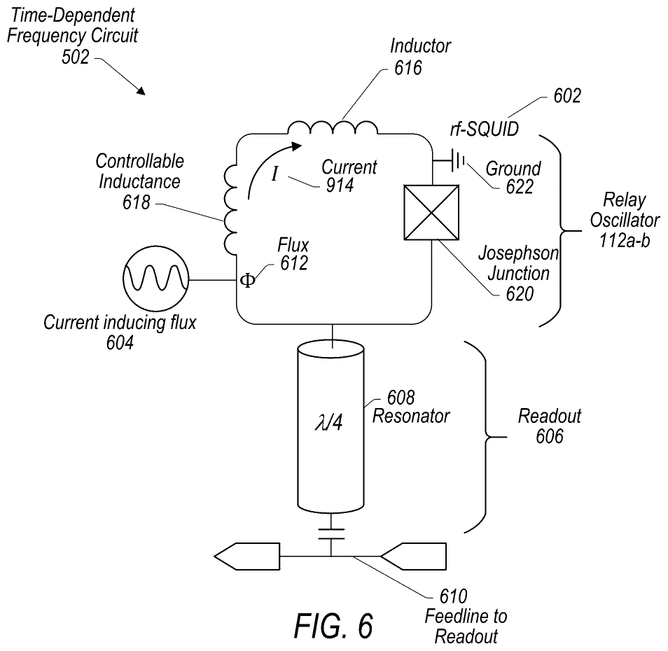

FIG. 6 is a diagram providing additional details regarding a hardware configuration used to implement a relay oscillator with a time-dependent frequency, according to some embodiments.

In some embodiments, a superconducting quantum interference device (SQUID) can be used in a circuit used to implement a relay oscillator with time-dependent frequency along with a controllable current line that induces a flux in the circuit. For example, time-dependent frequency circuit 502 includes rf-SQUID 602 and current line 604 that induces flux 612. Note the added flux 612 causes adjustments to the circuit flux 618 and current 614. The rf-SQUID 602 and current inducing flux 604 can be treated as a flux-tunable inductor, wherein changing the inductance of a LC-resonator changes the frequency of the time-dependent frequency circuit 502. In order to make the frequency time-dependent, a time dependent flux bias may be applied to a SQUID terminated resonator, such as shown in FIG. 6. In some embodiments, time-dependent frequency circuit 602 also includes Josephson junction 620 which is grounded 622. In some embodiments, the Josephson junction 620 and inductor 616 (along with controllable inductor 618) may form a part of relay oscillator 112a-b or relay oscillators in set of relay oscillators 202, 204, or 206. For Note that relay oscillator 112a-b may refer to any relay oscillator referenced herein. Note that in some embodiments relay oscillator 112a-b further includes a capacitor in parallel with the inductance and Josephson junction. However, for simplification purposes, the capacitor is not shown in FIG. 6.

In some embodiments, a value of the relay oscillator 112a-b may be read via readout 606. For example, a position degree of freedom of the relay oscillator 112a-b may be readout via readout 606. In some embodiments, readout 606 includes a resonator 608 which may have a length corresponding to ¼ the wavelength of the signal being readout from the relay oscillator 112a-b. Also, readout 606 may include feedline 610.

Note that inducing the flux in the time-dependent frequency circuit 502 via the current line 604 and resulting induced flux 612 allows for the Josephson inductance 618 to be tuned. This inductance is in series with the resonator inductance 616 so it simply adds to the L term of the LC oscillator. In the time-dependent frequency circuit 502 shown in FIG. 6 there is a voltage antinode at the capacitor below the resonator 606 and a voltage node as the SQUID end, which is grounded.

In some embodiments, the following function may be used for the time-dependent frequency:

$${ω}_{r} ( t ) = {ω}_{f}^{( r )} σ ( {k}_{r} ( t - {t}_{r} ) ) + {ω}_{r}$$

When a time-dependent frequency is used, the equation of motion for the average position of the relay oscillator 112a-b becomes:

$${m}_{r} \frac{{d}^{2} {ϕ}_{r}}{d {t}^{2}} + γ {m}_{r} \frac{d {ϕ}_{r}}{d t} = - ( - 2 {λ}_{A} ( t ) ( {ϕ}_{y} - {ϕ}_{r} ) + {λ}_{B} ( t ) {ϕ}_{b} + {λ}_{X} ( t ) {ϕ}_{x} + {m}_{r} {ω}_{r}^{2} ( t ) {ϕ}_{r} ) + \sqrt{2 {m}_{r} ( t ) {k}_{B} T} \frac{d {W}_{t}^{( r )}}{d t}$$

$$Or$$

$${m}_{γ} \frac{{d}^{2} {ϕ}_{r}}{d {t}^{2}} + γ {m}_{γ} \frac{d {ϕ}_{r}}{d t} = - ( - 2 {λ}_{A} ( t ) ( {ϕ}_{y} - {ϕ}_{r} ) - 2 {λ}_{B} ( t ) ( {ϕ}_{r} - {ϕ}_{b} ) + 2 {λ}_{X} ( t ) ( {ϕ}_{x} - {ϕ}_{r} ) + {m}_{r} {ω}_{r}^{2} ( t ) {ϕ}_{r} ) + \sqrt{2 {m}_{r} ( t ) {k}_{B} T} \frac{d {W}_{t}^{( r )}}{d t}$$

Note that since frequency is a function of capacitance and inductance, e.g.

$$( ω = \frac{1}{\sqrt{LC}} ) ,$$

by adjusting the inductance (L), the frequency of the circuit can be controlled. For example, as discussed above, a SQUID can be treated as a flux-tunable inductor, and by changing the inductance of the flux-tunable inductor, the inductance of an LC resonator can be changed, which also changes the LC resonator's frequency. For example, a time dependent flux bias can be applied to a SQUID terminated resonator.

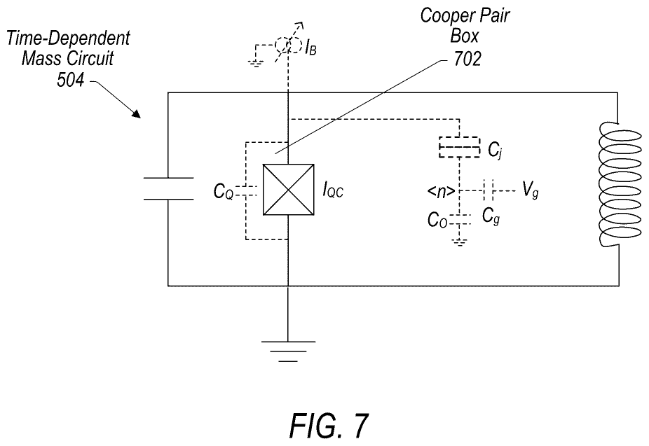

FIG. 7 is a diagram providing additional details regarding a hardware configuration used to implement a relay oscillator with a time-dependent mass, according to some embodiments.

A mass of an oscillator, is given by

$$m = {ϕ}_{0}^{2} C ,$$

where C is the capacitance of the circuit used to implement the oscillator and ϕ₀=h/2e is the reduced magnetic flux of the circuit used to implement the oscillator, e.g. a constant. Also, e is the elementary charge and h is Planck's constant. In some embodiments, a Cooper-pair box, such as Cooper-pair box 702, may be used to change the capacitance of the circuit. This allows the oscillator mass to change as a function of time, in response to control signals from a controller. The gate volage modulates the charge transfer through the small junction in the Cooper-pair box, thus leading to a gate-dependent capacitance.

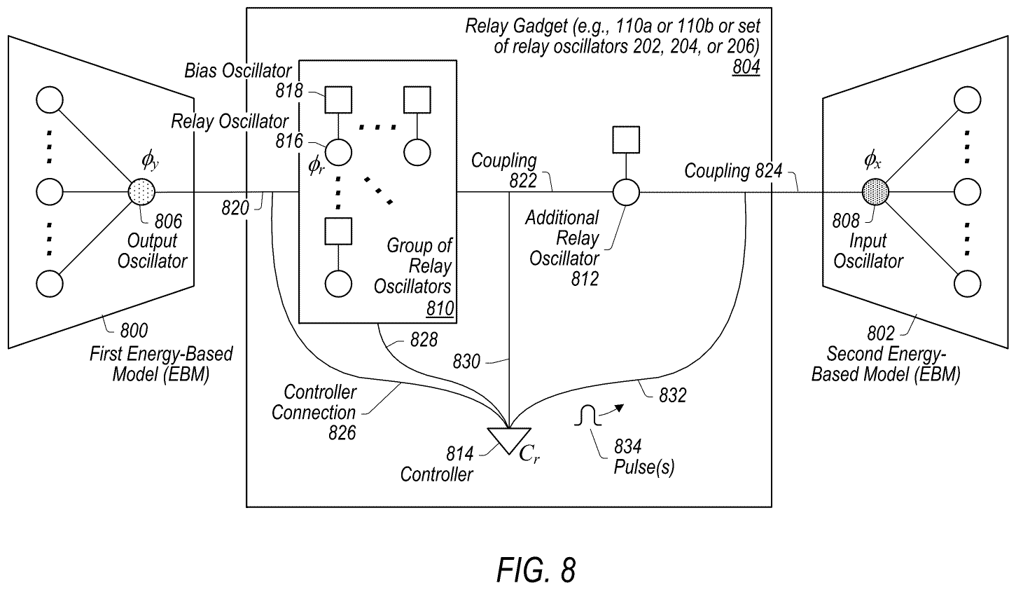

FIG. 8 is a high-level diagram illustrating an output oscillator, an input oscillator, and a relay gadget, wherein the relay gadget comprises a group of relay oscillators and is configured to relay thermodynamic information between the output oscillator and the input oscillator and includes bias oscillators, according to some embodiments.

In some embodiments, thermodynamic information is relayed from a first energy-based model (EBM) 800 to a second energy-based model (EBM) 802 via relay gadget 804 (e.g., 106a or 106b). The thermodynamic information of EBM 800 is outputted via output oscillator 806 and inputted into input oscillator 808 via relay gadget 804. The thermodynamic information may include, for example, samples of thermodynamic equilibrium of output oscillator 806, or the expectation value of the output oscillator 806. The expectation value is at least derivable based on samples values of the output oscillator 806. Output oscillator 806 may be governed by a potential wherein the potential follows a single-well potential, double-well potential, multi-well potential, or any generic potential that may be engineered. The output oscillator 806 may also be coupled to other oscillators belonging to EBM 800.

In some embodiments, an expectation value of one or more degrees of freedom of output oscillator 806 may be influenced by a potential of output oscillator 806 as well as couplings between output oscillator 806 and one or more oscillators belonging to first energy-based model 800. Potentials governing the dynamics of the output oscillator 806 may have multiple wells. With generic arbitrary potentials (e.g. multiple wells) and coupling between output oscillator 806 and one or more oscillators belonging to first energy-based model 800, the position degrees of freedom of the output oscillators can hop between wells. As described herein, a relay gadget provides a solution to approximate an expectation value of the output oscillator. Furthermore, utilizing the expectation value allows for forwards and backwards propagation. For example, using an approximated expectation value in forwards and backwards propagation may provide better results than using a sample value, as the expectation value better represents the state of the oscillator whose degree of freedom value is being relayed to a second oscillator.

Relay gadget 804 comprises a group of relay oscillators 810 and an additional relay oscillator 812. The group of relay oscillators 810 comprises one or more relay oscillators arranged with respective bias oscillators (e.g., relay oscillator 816 arranged with bias oscillator 818). As described later, relay oscillators in oscillator group 810 may be configured and coupled in various ways (e.g. temporally and spatially) to transfer thermodynamic information. The additional relay oscillator 812 is connected to bias oscillator 820. As discussed later, the additional relay oscillator 812 may be configured and coupled in various ways to transfer thermodynamic information. For example, the group of relay oscillators 810 transfers thermodynamic information to additional relay oscillator 812 via coupling 822. Coupling 822 may be controlled by on-chip classical controller 814.

Output oscillator 806 is coupled to the one or more relay oscillators of the group of relay oscillators 810 via on-chip classical controller 814. On-chip classical controller 814 may send a pulse or a group of pulses to cause couplings between oscillators (e.g., coupling between output oscillator 806 and relay oscillator 816) or relay oscillators like 816 and a bias oscillator like 818 via 828. Coupling is represented by coupling 820, 822, 824 and oscillators may be coupled or not coupled. When coupling is on, parameters of respective coupled oscillators affect the other oscillator it is coupled to. Couplings between oscillators within the group of relay oscillators 810 are not expressly shown in FIG. 8 to emphasize that the coupling may take different configurations (e.g. temporal or spatial configurations as detailed below). Nevertheless, on-chip classical controller 814 may cause a first set of one or more pulses to be emitted through controller connection 826, wherein the first set of pulses couples one or more relay oscillators of the group of relay oscillators 810 to the output oscillator 806 (e.g., turn on coupling 820). The on-chip classical controller 814 is further configured to cause a second set of one or more pulses to be emitted through 830, wherein the second set of pulses couples one or more relay oscillators of the group of relay oscillators 810 to the additional relay oscillator 812 (e.g., turn on coupling 822). The on-chip classical controller 814 is further configured to cause a third set of one or more pulses (for example, set of pulses 834) to be emitted, wherein the third set of pulses 834 couples the additional relay oscillator 812 to the input oscillator 808 (e.g., turn on coupling 824).

In some embodiments, an additional relay oscillator 812 takes on an expectation value of an output oscillator 806 based at least in part on a coupling or couplings between a group of relay oscillators 810, wherein respective relay oscillators of group 810 comprise respective sample values of the output oscillator 806. The additional relay oscillator 812 may take on the expectation value of output oscillator 806 based at least on respective sample values taken on by respective relay oscillators. Furthermore, additional relay oscillator 812 may transfer the taken on expectation value to input oscillator 808 via controller 814 causing coupling 826 to turn on.

In some embodiments, bias oscillators such as bias oscillator 818 may be used, for example, to stabilize relay oscillators of the relay gadget. In some embodiments, relay gadget 804 may be implemented without bias oscillators such as 818.

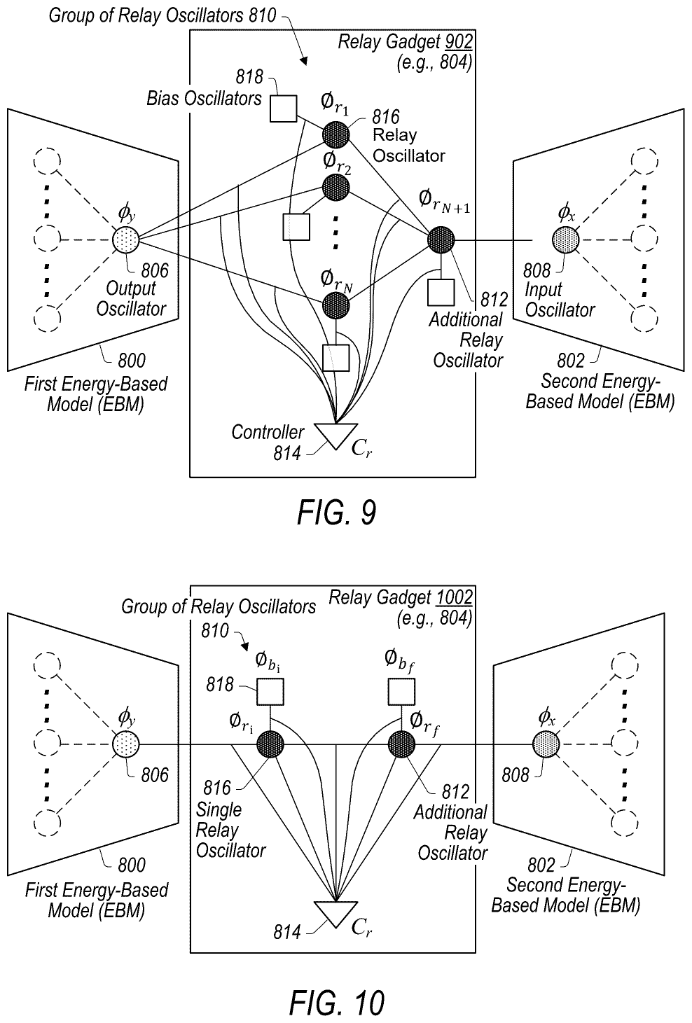

FIG. 9 is a high-level diagram illustrating a spatial analogue relay gadget, wherein respective ones of relay oscillators of a group of relay oscillators are configured to store respective sample values of an output oscillator, according to some embodiments.

In some embodiments, relay gadget 902 may be a spatial analogue relay gadget. In some embodiments, controller 814 sends a first set of one or more pulses wherein the first set of pulses causes output oscillator 806 of first energy-based model (EBM) 800 to be coupled to at least one or more relay oscillators {(ϕᵣ_{₁}, ϕᵣ_{₂}, . . . ϕᵣ_{_{N}}}, in the group of relay oscillators 810. Group of relay oscillators 810 comprises a plurality of relay oscillators, wherein respective relay oscillators {ϕᵣ_{₁}, ϕᵣ_{₂}, . . . ϕᵣ_{_{N}}}, are configured to store a sample of the output oscillator 806 based at least in part on respective couplings between the respective ones of the relay oscillators (e.g., 816) of the group of relay oscillators 810 and the output oscillator 806. The on-chip classical controller 814 is further configured to cause another set of one or more pulses to be emitted, wherein the other set of pulses turns off the respective couplings between the output oscillator 806 and the respective ones of the relay oscillator of the group of relay oscillators 810 at different times. This may allow different samples of the output oscillator 806 to be stored on the respective ones of the relay oscillators {ϕᵣ_{₁}, ϕᵣ_{₂}, . . . ϕᵣ_{_{N}}}.

On-chip classical controller 814 may be further configured to cause a second set of one or more pulses to be emitted, wherein the second set of pulses turns on the coupling between respective ones of the relay oscillators with sample values of the output oscillator 106 to an additional relay oscillator 812. The coupling is configured to transfer an approximation of the expectation value of output oscillator 806 based at least in part on the sample values stored on respective relay oscillators in the first group of relay oscillators 810. Once the additional relay oscillator 812 is tuned to the expectation value of output oscillator 806, controller 814 may cause a set of one or more pulses that may cause the additional relay oscillator to be coupled to input oscillator 808. In some embodiments, bias oscillators such as bias oscillator 818 may be used, for example, to stabilize relay oscillators of the relay gadget. In some embodiments, relay gadget 804 may be implemented without bias oscillators such as 818.

FIG. 10 is a high-level diagram illustrating a temporal analogue relay gadget, wherein a group of relay oscillators comprises a single relay oscillator, according to some embodiments.

In some embodiments, relay gadget 1002 may be a temporal analogue relay gadget. In some embodiments, the group of relay oscillators 810 comprises a single relay oscillator 816. The single relay oscillator 816 is configured to store a sample of the output oscillator 806 based at least in part on the coupling between the single relay oscillator 816 and the output oscillator 806. The coupling between output oscillator 806 and single relay oscillator 816 is caused by a first set of one or more pulses emitted from on-chip classical controller 814. The on-chip classical controller 814 is configured to cause a second set of one or more pulses to be emitted, wherein the second set of pulses causes the single relay oscillator 816 to be coupled to additional relay oscillator 812. The sequence of emitting the first set of pulses and then emitting the second set of pulses may be repeated numerous times. Each instance the sequence of the sequential sets of pulses is emitted, the position of additional relay oscillator 812 is incrementally adjusted. Each adjustment may converge the additional relay oscillator 812 to the expectation value of output oscillator 806.

In some embodiments, bias oscillators such as bias oscillator 818 may be used to stabilize relay oscillators of the relay gadget. In some embodiments, relay gadget 804 may be implemented without bias oscillators such as 818.

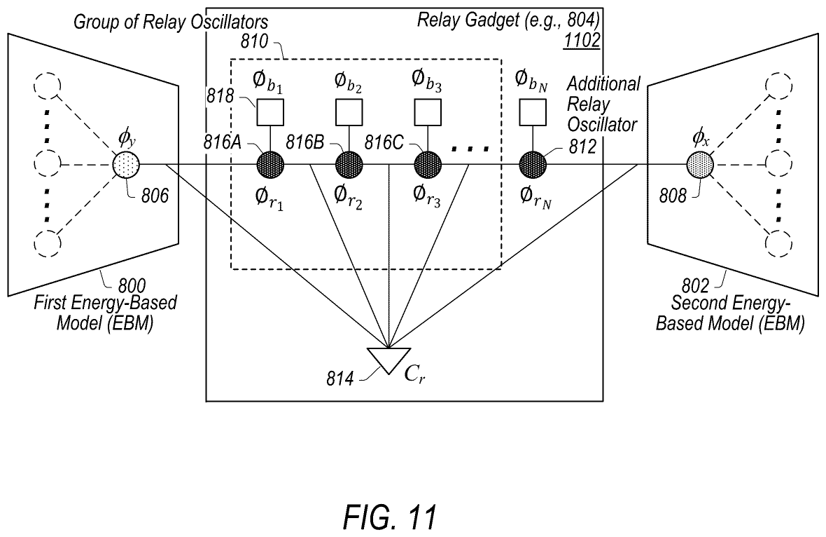

FIG. 11 is a high-level diagram illustrating a series analogue relay gadget, wherein a group of relay oscillators comprises a plurality of relay oscillators arranged in series, according to some embodiments.

In some embodiments, relay gadget 1102 may be a series analogue relay gadget. FIG. 11 shows a drawing of a series analogue relay gadget 804 such as shown in some embodiments. The group of relay oscillators 810 comprises a plurality of relay oscillators {ϕᵣ_{₁}, ϕᵣ_{₂}, . . . }(e.g. relay oscillator 816A, 816B, 816C) arranged one after another in series. Each relay oscillator has a product of mass and frequency squared. The first relay oscillator 816A, ϕᵣ_{₁}, has the smallest product of mass and frequency squared. The next relay oscillator 816B, ϕᵣ_{₂}, has a product of mass and frequency squared larger than the previous relay oscillator 816A, ϕᵣ_{₁}. This trend of increasing the product of mass and frequency squared continues for each subsequent relay oscillator in the group of relay oscillators 810. As last in the chain of relay oscillators, the additional relay oscillator 812 has the largest product of mass and frequency squared. The couplings between relay oscillators and the coupling between the output oscillator 806 and the first relay oscillator 816A, ϕᵣ_{₁}, may be turned on at the same time and allowed to evolve thermodynamically according to Langevin dynamics. Once coupling is initiated, each successive relay oscillator takes continuous samples of the previous oscillator it is coupled to. Furthermore, each successive relay oscillator may be a closer approximation of the expectation value of the output oscillator 806. In this manner, additional relay oscillator 812 approximates an expectation value of input oscillator 806. At this point, coupling between the additional relay oscillator 812 and input oscillator 808 may be turned on and the thermodynamic information may be transferred to input oscillator 808. The number of relay oscillators and the timing of coupling may be chosen beforehand and optimized for a desired precision or accuracy of the expectation value of the output relay oscillator.

In some embodiments, bias oscillators such as bias oscillator 818 may be used to stabilize relay oscillators of the relay gadget. In some embodiments, relay gadget 804 may be implemented without bias oscillators such as 818.

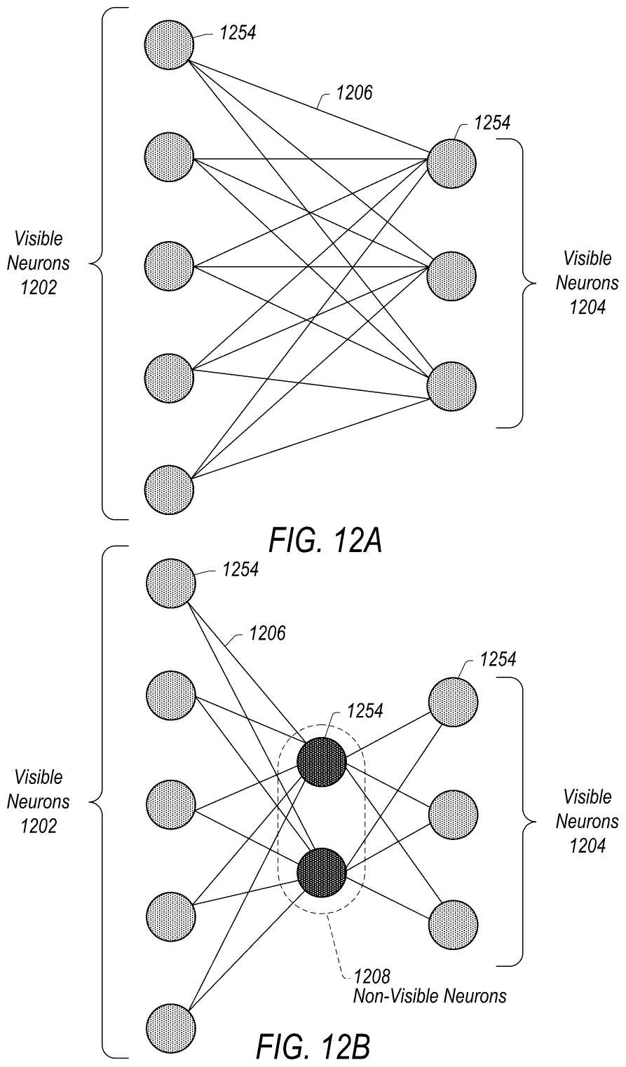

FIG. 12A illustrates example couplings between visible neurons of an energy-based model (EBM), according to some embodiments.

In some embodiments, input neurons and output neurons of an energy-based model, such as visible neurons 1202 and visible neurons 1204, may be directly linked via connected edges 1206. As shown in FIG. 12A, a given visible neuron 1202 of the five shown in the figure is connected, via edges 1206, to each of the respective three visible neurons 1204. A person having ordinary skill in the art should understand that FIG. 12A is meant to represent example embodiments of a graph architecture implemented using a thermodynamic chip that may be applied and that specific numbers of visible neurons 1202 and/or visible neurons 1204 shown in the figure are not meant to be restrictive. Additional configurations combining more/less visible neurons 1202 and/or visible neurons 1204 are also encompassed by the discussion herein. In addition, recall that neurons are logical representations of physical oscillators, such that, when describing neurons in FIGS. 12A and 12B, it should be understood that neurons and edges are implemented using oscillators and couplings.

FIG. 12B illustrates example couplings between visible neurons and non-visible neurons (e.g., hidden neurons) of an energy-based model (EBM), according to some embodiments.

In some embodiments, FIG. 12B may resemble additional example embodiments of an energy-based model architecture implemented using a thermodynamic chip. As shown in the figure, additional non-visible neurons 1208 may be used, which are respectively coupled, via edges 1206, to both visible neurons 1202 and to visible neurons 1204. Note that while the non-visible neurons are “not visible” from the perspective of inputs and outputs, the non-visible neurons may each correspond to a given oscillator. In addition, it may be noted that, in some embodiments that make use of non-visible neurons, no direct connections, via edges 1206, may be implemented between visible neurons 1202 and visible neurons 1204, but rather connections are routed firstly via non-visible neurons 1208, as shown in FIG. 12B. Couplings between visible and non-visible neurons may be additionally referred to herein as “layers” of a given energy-based model architecture that is implemented using a thermodynamic chip, according to some embodiments.

FIG. 13 is a high-level diagram illustrating oscillators included in a substrate of the thermodynamic chip and mapping of the oscillators to logical neurons of the thermodynamic chip, according to some embodiments.

In some embodiments, a substrate 1302 may be included in a thermodynamic chip, such as any one of the thermodynamic chips described above. Oscillators 1304 of substrate 1302 may be mapped in a logical representation 1352 to neurons 1354, as well as weights and biases (shown in FIG. 14). In some embodiments, oscillators 1304 may include oscillators with potentials ranging from a single well potential to a dual-well potential and may be mapped to visible neurons, weights, and biases.

In some embodiments, Josephson junctions and/or superconducting quantum interference devices (SQUIDS) may be used to implement and/or excite/control the oscillators 1304. In some embodiments, the oscillators 1304 may be implemented using superconducting flux elements (e.g., qubits). In some embodiments, the superconducting flux elements may physically be instantiated using a superconducting circuit built out of coupled nodes comprising capacitive, inductive, and Josephson junction elements, connected in series or parallel, such as shown in FIG. 13 for oscillator 1304. However, in some embodiments, generally speaking various non-linear flux loops may be used to implement the oscillators 1304, such as those having single-well potential, double-well potential, or various other potentials, such as a potential somewhere between a single-well potential and a double-well potential.

FIG. 14 is an additional high-level diagram illustrating oscillators included in a substrate of the thermodynamic chip mapped to logical neurons, weights, and biases of a given neuro-thermodynamic computing system, according to some embodiments.

While synapses such as weights and biases are not shown in FIG. 13 for ease of illustration, respective ones of the visible neurons 1354 of FIG. 13 may each have an associated bias, and edges connecting the neurons 1354 may have associated weights. For example, FIG. 12 illustrates an arrangement of five visible neurons along with associated weights and biases. Each of the weights and biases may be mapped to oscillators in the thermodynamic chip, as well as the visible (and non-visible) neurons being mapped to oscillators in the thermodynamic chip. For example, FIG. 14 shows a portion of a thermodynamic chip, wherein weights and biases associated with a given neuron 1454 are shown. For example, bias 1456 may be a bias value for visible neuron 1454 and weights 1458 and 1460 may be weights for edges formed between visible neuron 1454 and other visible neurons of the thermodynamic chip. As shown in FIG. 14, each of the chip elements (visible neuron 1454, bias 1456, weight 1458, and weight 1460) may be mapped to separate ones of oscillators 1404. This may allow the visible neurons (and/or hidden neurons), weights, and biases to have independent degrees of freedom within a given thermodynamic chip that can separately evolve.

FIG. 15 is a high-level flowchart illustrating a process of emulating deep neural diffusion using a deep energy-based model implemented on one or more thermodynamic chips to generate sample values, according to some embodiments.

In some embodiments, methods, systems, and apparatuses such as described herein may be used to emulate diffusion and generate sample input values of a deep neural network. An example process of an embodiment may be disclosed as follows. At block 1502, a deep EBM implemented on one or more thermodynamic chips may be enabled to thermodynamically evolve. In some embodiments, the deep EBM may comprise one or more EBMs and one or more oscillators that implement one or more energy potentials, wherein the one or more energy potentials govern the thermodynamic evolution.

In some embodiments, block 1502 may lead to block 1504 describing that a first set of relay oscillators may be coupled to respective oscillators of respective EBMs. For example, relay oscillators of a relay gadget may be coupled to one or more input oscillators or one or more output oscillators of respective EBMs. The coupling along with more thermodynamic evolution may enable gradient terms of respective EBMs to be determined and stored onto one or more oscillators of the first set of relay oscillators such as described at block 1506. For example, respective gradients of the respective EBMs with respect to one or more input values for the respective EBMs, wherein the one or more energy potentials are not perturbed (unperturbed gradients), are determined. Such gradients may refer to the gradients described in equation 2.2 and the surrounding description.

At block 1508, a second set of relay oscillators is introduced, wherein the second set of relay oscillators may be coupled to oscillators of respective EBMs. The coupling may be similar to how the first set of relay oscillators are coupled with oscillators of respective EBMs such as described immediately above; however, a key distinction is that one or more energy potentials of the EBMs may be perturbed while coupled to the one or more relay oscillators of the second set of relay oscillators. Consequently, at block 1510, the coupling may enable gradients of the EBMs with respect to one or more input values for the EBMs to be determined for perturbed energy potentials (perturbed gradients). Such perturbed gradients may refer to the gradients described in equation 2.9 and the surrounding description.

At block 1512, a third set of relay oscillators are introduced, wherein the third set of relay oscillators may be coupled to the first and second sets of relay oscillators. For such a coupling, the first and second sets of relay oscillators are held static at the gradient values obtained from previous coupling. The coupling of the third set of relay oscillators to the other two sets may be designed such that thermodynamic evolution of the third set of relay oscillators causes the third set of relay oscillators to compute a difference between the perturbed and unperturbed gradients. For example, see equation 2.12 and the surrounding description.

Alternative to block 1504, block 1502 may lead to block 1514. At block 1514, multiple position or momentum measurements of input or output oscillators of a given EBM may be measured. Such measurements may be sent to a classical computing device wherein, at block 1516, gradient terms of the given EBM with respect to one or more input values for the given EBM may be computed. Measurements may be taken in a forwards pass wherein one or more potentials of the EBMs are not perturbed and measurements may be taken in a backwards pass the wherein one or more potentials of the EBMs are perturbed. In such an embodiment, the measurements may be used to determine the unperturbed and perturbed gradients.

At block 1518, a classical computing device may determine a gradient of the deep EBM, with respect to a thermodynamic input of the deep EBM, based on the thermodynamic evolution of the deep EBM. In some embodiments, wherein blocks 1506-1512 are implemented, the third set of relay oscillators may be further coupled to output oscillators of respective EBMs to create the perturbed potential in equation 2.11. As described in FIG. 1, relay oscillators of the third group of relay oscillators may in turn be coupled to an EBM. For example, relay oscillators of the third set of relay oscillators that correspond to a last block may be coupled with one or more output oscillators of the last block and then thermodynamically evolve. Then, other relay oscillators of the third set of relay oscillators that correspond to a second to last block may be coupled with one or more output oscillators of the second to last block and then thermodynamically evolve. In this manner, relay oscillators of the third set of relay oscillators may be coupled with output oscillators of a previous block and thermodynamically evolve until the first block corresponding to a first EBM of the deep EBM is reached. In such an embodiment, relay oscillators of the third set of relay oscillators corresponding to the first EBM may reach the desired gradient of the deep EBM such as described in equation 2.3 and the surrounding description (see FIGS. 1 and 2). In embodiments, wherein blocks 1514 and 1516 are implemented, a classical computing device may calculate the deep EBM gradient based on the multiple measurements obtained.

At block 1520, a classical computing device may generate sample input values for the deep EBM based on the gradients of the deep EBM. In such an embodiment, deep neural diffusion may be emulated using one or more thermodynamic chips.

### Illustrative Computer System

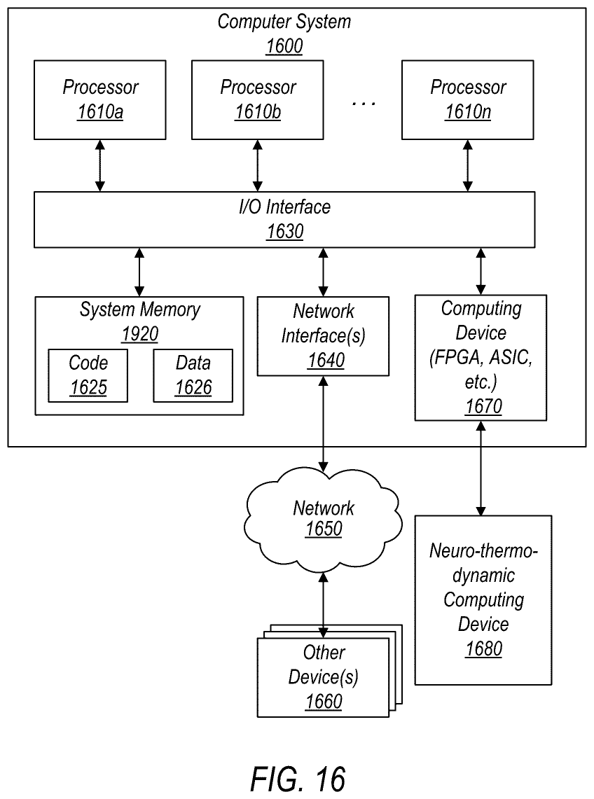

FIG. 16 is a block diagram illustrating an example computer system that may be used in at least some embodiments. In some embodiments, the computing system shown in FIG. 16 may be used, at least in part, to implement any of the protocols, techniques, etc. described above in FIGS. 1-15. For example, program instructions that implement protocols, techniques, etc. described herein may be stored in a non-transitory computer readable medium and/or may be executed by one or more processors, such as the processors of computer system 1600.

In the illustrated embodiment, computer system 1600 includes one or more processors 1610 coupled to a system memory 1620 (which may comprise both non-volatile and volatile memory modules) via an input/output (I/O) interface 1630. Computer system 1600 further includes a network interface 1640 coupled to I/O interface 1630. Classical computing functions may be performed on a classical computer system, such as computing computer system 1600.

Additionally, computer system 1600 includes computing device 1670 coupled to thermodynamic chip 1680. In some embodiments, computing device 1670 may be a field programmable gate array (FPGA), application specific integrated circuit (ASIC) or other suitable processing unit. In some embodiments, computing device 1670 may be a similar computing device as described in FIGS. 1-15, such as classical computing device 118. In some embodiments, thermodynamic chip 1680 may be a similar thermodynamic chip as described in FIGS. 1-15, such as thermodynamic chip(s) 100.

In various embodiments, computer system 1600 may be a uniprocessor system including one processor 1610, or a multiprocessor system including several processors 1610 (e.g., two, four, eight, or another suitable number). Processors 1610 may be any suitable processors capable of executing instructions. For example, in various embodiments, processors 1610 may be general-purpose or embedded processors implementing any of a variety of instruction set architectures (ISAs), such as the x86, PowerPC, SPARC, or MIPS ISAs, or any other suitable ISA. In multiprocessor systems, each of processors 1610 may commonly, but not necessarily, implement the same ISA. In some implementations, graphics processing units (GPUs) may be used instead of, or in addition to, conventional processors.

System memory 1620 may be configured to store instructions and data accessible by processor(s) 1610. In at least some embodiments, the system memory 1620 may comprise both volatile and non-volatile portions; in other embodiments, only volatile memory may be used. In various embodiments, the volatile portion of system memory 1620 may be implemented using any suitable memory technology, such as static random-access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random-access memory (ReRAM), three-dimensional NAND technologies, Ferroelectric RAM, magneto resistive RAM (MRAM), or any of various types of phase change memory (PCM) may be used at least for the non-volatile portion of system memory. In the illustrated embodiment, program instructions and data implementing one or more desired functions, such as those methods, techniques, and data described above, are shown stored within system memory 1620 as code 1625 and data 1626.

In some embodiments, I/O interface 1630 may be configured to coordinate I/O traffic between processor 1610, system memory 1620, computing device 1670, and any peripheral devices in the computer system, including network interface 1640 or other peripheral interfaces such as various types of persistent and/or volatile storage devices. In some embodiments, I/O interface 1630 may perform any necessary protocol, timing or other data transformations to convert data signals from one component (e.g., system memory 1620) into a format suitable for use by another component (e.g., processor 1610). In some embodiments, I/O interface 1630 may include support for devices attached through various types of peripheral buses, such as a variant of the Peripheral Component Interconnect (PCI) bus standard or the Universal Serial Bus (USB) standard, for example. In some embodiments, the function of I/O interface 1630 may be split into two or more separate components, such as a north bridge and a south bridge, for example. Also, in some embodiments some or all of the functionality of I/O interface 1630, such as an interface to system memory 1620, may be incorporated directly into processor 1610.

Network interface 1640 may be configured to allow data to be exchanged between computing device 1600 and other devices 1660 attached to a network or networks 1650, such as other computer systems or devices. In various embodiments, network interface 1640 may support communication via any suitable wired or wireless general data networks, such as types of Ethernet network, for example. Additionally, network interface 1640 may support communication via telecommunications/telephony networks such as analog voice networks or digital fiber communications networks, via storage area networks such as Fibre Channel SANs, or via any other suitable type of network and/or protocol.

In some embodiments, system memory 1620 may represent one embodiment of a computer-accessible medium configured to store at least a subset of program instructions and data used for implementing the methods and apparatus discussed in the context of FIG. 1 through FIG. 15. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computer system 1600 via I/O interface 1630. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computer system 1600 as system memory 1620 or another type of memory. In some embodiments, a plurality of non-transitory computer-readable storage media may collectively store program instructions that when executed on or across one or more processors implement at least a subset of the methods and techniques described above. A computer-accessible medium may further include transmission media or signals such as electrical, electromagnetic, or digital signals, conveyed via a communication medium such as a network and/or a wireless link, such as may be implemented via network interface 1640. Portions or all of multiple computing devices such as that illustrated in FIG. 16 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computer system”, as used herein, refers to at least all these types of devices, and is not limited to these types of devices.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g., SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures above and described herein represent exemplary embodiments of methods. The methods may be implemented in software, hardware, or a combination thereof. The order of method may be changed, and various elements may be added, reordered, combined, omitted, modified, etc.

It will also be understood that, although the terms first, second, etc., may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

Various modifications and changes may be made as would be obvious to a person skilled in the art having the benefit of this disclosure. It is intended to embrace all such modifications and changes and, accordingly, the above description is to be regarded in an illustrative rather than a restrictive sense.

What is claimed is:

1. A system comprising:
one or more classical computing devices configured to:
cause noise to be added to observed data according to a given noise level (t) to generate noisy observed data (yₜ); and
one or more thermodynamic chips, wherein the one or more thermodynamic chips comprise:
oscillators that implement a deep energy based model (EBM), wherein:
the deep EBM (Ee) comprises one or more EBMs;
the oscillators are configured to encode thermodynamic information in a position degree of freedom or a momentum degree of freedom and thermodynamically evolve;
respective oscillators of the deep EBM are neuron oscillators representing neuron values; and
other respective oscillators of the deep EBM are synapse oscillators representing trainable parameters (θ);
one or more input oscillators configured to provide input thermodynamic information to the deep EBM based on the noisy observed data; and
an output gadget, comprising one or more output oscillators, configured to receive output thermodynamic information from the deep EBM, wherein the output gadget stores an expectation value of the output thermodynamic information; and
wherein the one or more classical computing devices are further configured to:
cause the noisy observed data to be provided to the one or more input oscillators;
cause the oscillators that implement the deep EBM to thermodynamically evolve;
obtain a gradient of the deep EBM with respect to the noisy observed data
$$( {∇}_{{y}_{t}} {E}_{θ} ( {y}_{t} ; t ) ) ;$$
determine sampled data (\tilde{y}ₜ) based on the gradient of the deep EBM (∇_{y}_{ₜ}ε_{θ}(yₜ; t)), wherein the sampled data (\tilde{y}ₜ) represents one or more instances of input data sampled from a distribution conditional to a higher noise level (\tilde{y}ₜ˜p_{θ}(yₜ|xₜ₊₁)); and
cause the synapse oscillators representing trainable parameters (θ) to be updated based on the noisy observed data (yₜ) and the sampled data(\tilde{y}ₜ).

2. The system of claim 1, wherein:
the sampled data (\tilde{y}ₜ) is generated using a plurality of Langevin Markov chain Monte Carlo (MCMC) sampling steps for the given noise level (t).

3. The system of claim 1, wherein to cause the synapse oscillators to be updated based on the noisy observed data (yₜ) and the sampled data (\tilde{y}ₜ), the one or more classical computing devices are configured to:
determine a gradient of the deep EBM with respect to the synapse oscillators given the noisy observed data (∇_{θ}ε_{θ}(yₜ; t)); and
determine a gradient of the deep EBM with respect to the synapse oscillators given the sampled data (∇_{θ}ε_{θ}(\tilde{y}ₜ; t)),
wherein the gradient of the deep EBM with respect to the synapse oscillators given the noisy observed data (∇_{θ}ε_{θ}(yₜ; t)) is combined with the gradient of the deep EBM with respect to the synapse oscillators given the sampled data (∇_{θ}ε_{θ}(\tilde{y}ₜ; t)), to obtain a difference of gradients.

4. The system of claim 3, wherein the one or more classical computing devices are configured to:
obtain a plurality of instances (i∈{1,2, . . . , n}) of observed data;
for a given instance (i) of the plurality of instances of observed data:
cause noise to be added to the instance of observed data according to the given noise level (t) to generate an instance of noisy observed data (yₜ,i);
cause the instance of noisy observed data to be provided to the one or more input oscillators;
cause the oscillators that implement the deep EBM to thermodynamically evolve;
obtain a gradient of the deep EBM with respect to the instance of noisy observed data (∇_{y}_{_{t,i}}ε_{θ}(y_{t,i}; t));
determine an instance of sampled data (\tilde{y}_{t,i}) based on the gradient of the deep EBM (∇_{y}_{_{t,i}}ε_{θ}(y_{t,i}; t)), wherein the instance of sampled data (\tilde{y}_{t,i}) represents one or more instances of input data sampled from a distribution conditional to a higher noise level (\tilde{y}_{t,i}˜p_{θ}(y_{t,i}|x_{t+1,i})); and
cause the synapse oscillators representing trainable parameters (θ) to be updated based on the instance of noisy observed data and the instance of sampled data to determine an average parameter update.

5. The system of claim 1, wherein prior to causing the synapse oscillators representing the trainable parameters (θ) to be updated based on the noisy observed data (yₜ) and the sampled data (\tilde{y}ₜ), the one or more classical computing devices are configured to:
cause the synapse oscillators to be initialized to initial parameter values, wherein the initial parameter values are encoded in position degrees of freedom or momentum degrees of freedom of the synapse oscillators.

6. The system of claim 1, wherein the sampled data (\tilde{y}ₜ) of the deep EBM is utilized in at least one of the following:
a diffusion recovery likelihood protocol;
a denoising diffusion probabilistic model; or
a neural stochastic differential equation.

7. The system of claim 1,
wherein the observed data is:
an image;
a video;
a document;
an audio file; or
another multi-media file; and
wherein the noisy observed data is:
a modified version of the image with noise added according to the given noise level (t);
a modified version of the video with noise added according to the given noise level (t);
a modified version of the document with changes added (noise) according to the given noise level (t);
a modified version of the audio file with noise added according to the given noise level (t); or
a modified version of the another multi-media file with noise added according to the given noise level (t).

8. A method for training parameters (θ) of a deep energy based model (EBM), wherein the deep EBM (ε_{θ}) comprises oscillators, the method comprising:
adding noise to observed data according to a given noise level (t), wherein the noisy observed data (yₜ) is used as input to the deep EBM;
thermodynamically evolving the oscillators of the deep EBM, wherein the thermodynamic evolution enables a gradient of the deep EBM with respect to the noisy observed data (∇_{y}_{ₜ}ε_{θ}(yₜ; t)) to be determined;
obtaining a gradient of the deep EBM with respect to the noisy observed data (∇_{y}_{ₜ}ε_{θ}(yₜ; t));
determining sampled data (\tilde{y}ₜ) based on the gradient of the deep EBM (∇_{y}_{ₜ}ε_{θ}(yₜ; t)), wherein the sampled data (\tilde{y}ₜ) represents one or more instances of input data sampled from a distribution conditional to a higher noise level (\tilde{y}ₜ˜p_{θ}(yₜ|xₜ₊₁)); and
causing the synapse oscillators, representing trainable parameters (θ), to be updated based on the noisy observed data (yₜ) and the sampled data (\tilde{y}ₜ).

9. The method of claim 8, wherein to determine the sampled data (\tilde{y}ₜ) based on the gradient of the deep EBM (∇_{y}_{ₜ}ε_{θ}(yₜ; t)), the method further comprises:
performing a plurality of Langevin Markov chain Monte Carlo (MCMC) sampling steps.

10. The method of claim 8, wherein to cause the synapse oscillators, representing trainable parameters (θ), to be updated based on the noisy observed data (yₜ) and the sampled data (\tilde{y}ₜ), the method further comprises:
determining a gradient of the deep EBM with respect to the synapse oscillators given the noisy observed data (∇_{θ}ε_{θ}(yₜ; t)); and
determining a gradient of the deep EBM with respect to the synapse oscillators given the sampled data (∇_{θ}ε_{θ}(\tilde{y}ₜ; t)).

11. The method of claim 10 further comprising:
combining the gradient of the deep EBM with respect to the synapse oscillators given the noisy observed data (∇_{θ}ε_{θ}(yₜ; t)) with the gradient of the deep EBM with respect to the synapse oscillators given the sampled data (∇_{θ}ε_{θ}(\tilde{y}ₜ; t)), to obtain a difference of gradients.

12. The method of claim 8, wherein the method further comprises:
obtaining a plurality of instances (i∈{1,2, . . . , n}) of observed data; and
for a given instance (i) of the plurality of instances of observed data:
adding noise to the instance of observed data according to the given noise level (t), wherein the instance of noisy observed data (y_{t,i}) is used as input to the deep EBM;
thermodynamically evolving the oscillators of the deep EBM, wherein the thermodynamic evolution enables a gradient of the deep EBM with respect to the instance of noisy observed data (∇_{y}_{_{t,i}}ε_{θ}(y_{t,i}; t)) to be determined;
obtaining a gradient of the deep EBM with respect to the noisy observed data (∇_{y}_{_{t,i}}ε_{θ}(yₜ,i; t));
determining an instance of sampled data (\tilde{y}_{t,i}) based on the gradient of the deep EBM (∇_{y}_{_{t,i}}ε_{θ}(y_{t,i}; t)), wherein the sampled data (\tilde{y}_{t,i}) represents one or more instances of input data sampled from a distribution conditional to a higher noise level (\tilde{y}_{t,i}˜p_{θ}(y_{t,i}|x_{t+1,i}));
determining an average parameter update based on the instance of noisy observed data and the instance of sampled data; and
causing the synapse oscillators, representing trainable parameters (θ), to be updated based on the determined average parameter update.

13. The method of claim 8, wherein prior to causing the synapse oscillators, representing trainable parameters (θ), to be updated based on the noisy observed data and the sampled data, the method comprises:
initializing the synapse oscillators to initial parameter values, wherein the initial parameter values are encoded in position degrees of freedom or momentum degrees of freedom of the synapse oscillators.

14. The method of claim 8, wherein the sampled data of the deep EBM, are utilized in at least one of the following:
a diffusion recovery likelihood protocol;
a denoising diffusion probabilistic model; or
a neural stochastic differential equation.

15. The method of claim 8,
wherein the observed data is:
an image;
a video;
a document;
an audio file; or
another multi-media file; and
wherein the noisy observed data is:
a modified version of the image with noise added according to the given noise level (t);
a modified version of the video with noise added according to the given noise level (t);
a modified version of the document with changes added (noise) according to the given noise level (t);
a modified version of the audio file with noise added according to the given noise level (t); or
a modified version of the another multi-media file with noise added according to the given noise level (t).

16. A system, comprising:
one or more classical computing devices configured to:
add noise to observed data according to a given noise level (t), wherein the noisy observed data (yₜ) is used as input to a deep EBM;
cause oscillators of the deep EBM to thermodynamically evolve, wherein the thermodynamic evolution enables a gradient of the deep EBM with respect to the noisy observed data (∇_{y}_{ₜ}ε_{θ}(yₜ; t)) to be determined;
determine the gradient of the deep EBM with respect to the noisy observed data (∇_{y}_{ₜ}ε_{θ}(yₜ; t));
determine sampled data (\tilde{y}ₜ) based on the gradient of the deep EBM (∇_{y}_{ₜ}ε_{θ}(yₜ; t)), wherein the sampled data (\tilde{y}ₜ) represents one or more instances of input data sampled from a distribution conditional to a higher noise level (\tilde{y}ₜ˜p_{θ}(yₜ|xₜ₊₁)); and
determine updated parameters for the synapse oscillators representing trainable parameters (θ) based on the sampled data (\tilde{y}ₜ) and noisy observed data (yₜ).

17. The system of claim 16, wherein to cause the data for the deep EBM to be sampled, the one or more classical computing devices are further configured to:
perform a plurality of Langevin Markov chain Monte Carlo (MCMC) sampling steps to be performed.

18. The system of claim 16, wherein to cause the synapse oscillators to be updated from the initial thermodynamic values to updated thermodynamic values based on the sampled data and noisy observed data, the one or more classical computing devices are further configured to:
determine a gradient of the deep EBM with respect to the synapse oscillators given the noisy observed data (∇_{θ}ε_{θ}(yₜ; t)); and
determine a gradient of the deep EBM with respect to the synapse oscillators given the sampled data (∇_{θ}ε_{θ}(\tilde{y}ₜ; t)).

19. The system of claim 18, wherein the one or more classical computing devices are further configured to:
obtain a difference of gradients using the gradient of the deep EBM with respect to the synapse oscillators given the noisy observed data (∇_{θ}ε_{θ}(yₜ; t)) and the gradient of the deep EBM with respect to the synapse oscillators given the sampled data (∇_{θ}ε_{θ}(\tilde{y}ₜ; t)) to.

20. The system of claim 16, wherein the one or more classical computing devices are further configured to:
obtain a plurality of instances (i∈{1,2, . . . , n}) of observed data; and
for a given instance (i) of the plurality of instances of observed data:
cause noise to be added to the instance of observed data according to the given noise level (t), wherein the instance of noisy observed data (yₜ,j) is used as input to the deep EBM;
cause oscillators of the deep EBM to thermodynamically evolve, wherein the thermodynamic evolution enables a gradient of the deep EBM with respect to the instance of noisy observed data (∇_{y}_{_{t,i}}ε_{θ}(y_{t,i}; t)) to be determined;
obtain the gradient of the deep EBM with respect to the noisy observed data (∇_{y}_{_{t,i}}ε_{θ}(y_{t,i}; t));
determine an instance of sampled data (\tilde{y}ₜ,j) based on the gradient of the deep EBM (∇_{y}_{_{t,i}}ε_{θ}(y_{t,i}; t)), wherein the sampled data (\tilde{y}_{t,i}) represents one or more instances of input data sampled from a distribution conditional to a higher noise level (\tilde{y}_{t,i}˜p_{θ}(y_{t,i}|x_{t+1,i}));
determine an average parameter update based on the instance of noisy observed data and the instance of sampled data; and
cause the synapse oscillators, representing trainable parameters (θ), to be updated based on the determined average parameter update.

21. The system of claim 16, wherein prior to causing the synapse oscillators, representing trainable parameters (θ), to be updated based on the noisy observed data (yₜ) and the sampled data (\tilde{y}ₜ), the one or more computing devices are further configured to:
initialize the synapse oscillators to initial parameter values, wherein the initial parameter values are encoded in position degrees of freedom or momentum degrees of freedom of the synapse oscillators.

22. The system of claim 16, wherein the sampled data of the deep EBM, are utilized in at least one of the following:
a diffusion recovery likelihood protocol;
a denoising diffusion probabilistic model; or
a neural stochastic differential equation.

23. The system of claim 16,
wherein the observed data is:
an image;
a video;
a document;
an audio file; or
another multi-media file; and
wherein the noisy observed data is:
a modified version of the image with noise added according to the given noise level (t);
a modified version of the video with noise added according to the given noise level (t);
a modified version of the document with changes added (noise) according to the given noise level (t);
a modified version of the audio file with noise added according to the given noise level (t); or
a modified version of the another multi-media file with noise added according to the given noise level (t).
